(19) United States
(12) Patent Application Publication
(10) Pub. No.: US 2015/0018089 A1
(43) Pub. Date: Jan. 15, 2015

(54) ELECTRONIC GAMING SYSTEM WITH CODEGUARD

(71) Applicant: Marius Caldas, Ellijay, GA (US)

(72) Inventor: Marius Caldas, Ellijay, GA (US)

(73) Assignee: CADILLAC JACK, DULUTH, GA (US)

(21) Appl. No.: 13/941,679

(22) Filed: Jul. 15, 2013

(51) Int. Cl. G07F 17/32

(52) U.S. Cl. CPC G07F 17/3241
USPC 463/29

(57) ABSTRACT

Examples disclosed herein relate to systems and methods for validating the authenticity of one or more media associated with a gaming system. The systems and methods may utilize a RAM-based algorithm to validate such media. Further, the RAM-based algorithm by utilize a dirty bit validation procedure to validate the media.

### FIELD

The subject matter disclosed herein relates to an electronic gaming system and method of configuring a validation procedure for an electronic gaming system. More specifically, the disclosure relates to RAM-based media validation system and method, and associated gaming system configurations.

### INFORMATION

The gaming industry has numerous casinos located both worldwide and in the United States. A client of a casino or other gaming entity can gamble via various games of chance. For example, craps, roulette, baccarat, blackjack, and electronic or electromechanical games (e.g., a slot machine, a video poker machine, and the like) where a person may gamble on an outcome.

Historically, electronic gaming systems comprise a significant portion of a casino offering, and are therefore very important to the industry. However, as with many electronic systems, security concerns may need to be addressed. Due to the nature of electronic gaming systems, and their ability to accept and award high levels of money, it may be important that an operator can trust that the game and media running on an electronic gaming system is authentic, and not malware and/or other exploitable game. Additionally, due to the importance of electronic gaming systems, it is also important that any associated security systems not require significant down time, as an electronic gaming system needs to be usable by a player for the casino to recognize value from it.

### BRIEF DESCRIPTION OF THE FIGURES

Non-limiting and non-exhaustive examples will be described with reference to the following figures, wherein like reference numerals refer to like parts throughout the various figures.

FIG. 1 is an illustration of the electronic gaming device, according to one embodiment.

FIG. 2 is an illustration of an electronic gaming system, according to one embodiment.

FIG. 3 is a block diagram of the electronic gaming device, according to one embodiment.

FIG. 4 is another block diagram of the electronic gaming device, according to one embodiment.

FIG. 5 is a block diagram of an exemplary gaming device, according to one embodiment.

FIG. 6 is another block diagram of an exemplary gaming device, according to one embodiment.

FIG. 7 is a diagram of an exemplary memory layout, according to one embodiment.

FIG. 8A is an illustration of an exemplary program, according to one embodiment.

FIG. 8B is another illustration of an exemplary program, according to one embodiment.

FIG. 8C is another illustration of an exemplary program, according to one embodiment.

FIG. 9 is an illustration of the interrelationship of two programs, according to one embodiment.

FIG. 10 is an illustration of an electronic gaming system, according to one embodiment.

FIG. 11A is a first part of a validation process flow diagram, according to one embodiment.

FIG. 11B is a second part of the validation process flow diagram, according to one embodiment.

FIG. 12 is a flow diagram for ROM-based media validation, according to one embodiment.

FIG. 13 is another flow diagram for ROM-based media validation, according to one embodiment.

FIG. 14 is another flow diagram for ROM-based media validation, according to one embodiment.

FIG. 15 is another flow diagram for ROM-based media validation, according to one embodiment.

FIG. 16 is another flow diagram for ROM-based media validation, according to one embodiment.

### DETAILED DESCRIPTION

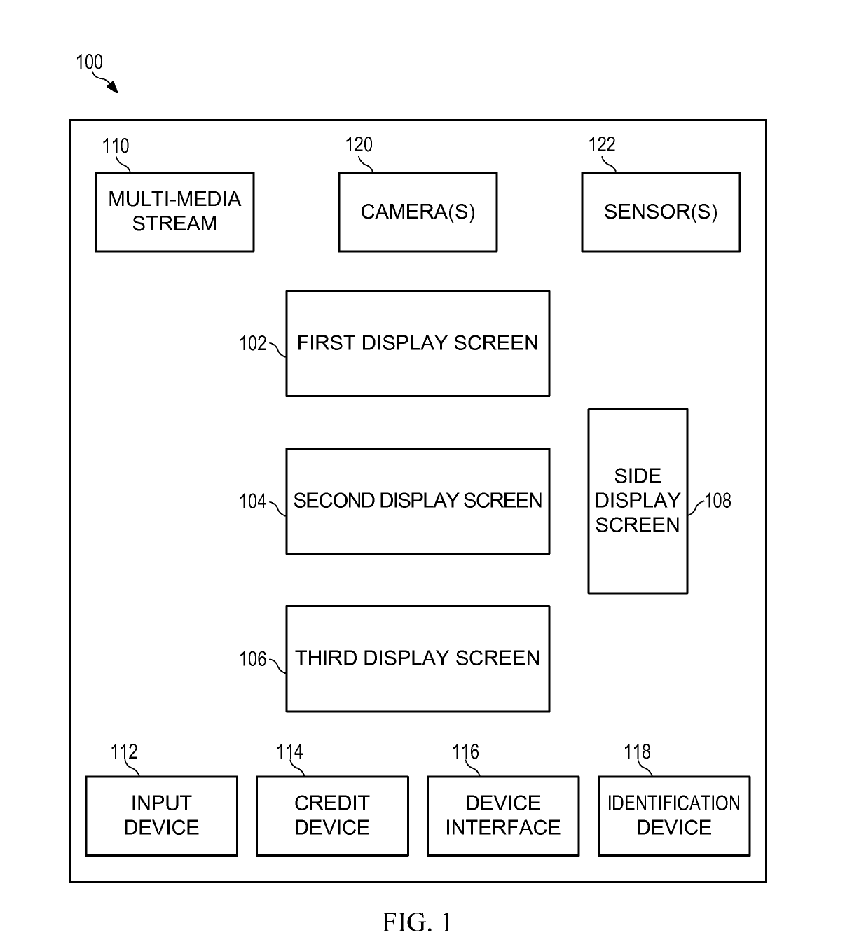

FIG. 1 is an illustration of an electronic gaming device 100. Electronic gaming device 100 may include a multi-media stream 110, a first display screen 102, a second display screen 104, a third display screen 106, a side display screen 108, an input device 112, a credit device 114, a device interface 116, an identification device 118, one or more cameras 120, and/or one or more sensors 122. Electronic gaming device 100 may display one, two, a few, or a plurality of multi-media streams 110, which may be obtained from one or more gaming tables, one or more electronic gaming devices, a central server, a video server, a music server, an advertising server, another data source, and/or any combination thereof.

Multi-media streams may be obtained for an entertainment event, a wagering event, a promotional event, a promotional offering, an advertisement, a sporting event, any other event, and/or any combination thereof. For example, the entertainment event may be a concert, a show, a television program, a movie, an Internet event, and/or any combination thereof. In another example, the wagering event may be a poker tournament, a horse race, a car race, and/or any combination thereof. The advertisement may be an advertisement for a casino, a restaurant, a shop, any other entity, and/or any combination thereof. The sporting event may be a football game, a baseball game, a hockey game, a basketball game, any other sporting event, and/or any combination thereof. These multi-media streams may be utilized in combination with the gaming table video streams.

Input device 112 may be mechanical buttons, electronic buttons, mechanical switches, electronic switches, optical switches, a slot pull handle, a keyboard, a keypad, a touch screen, a gesture screen, a joystick, a pointing device (e.g., a mouse), a virtual (on-screen) keyboard, a virtual (on-screen) keypad, biometric sensor, or any combination thereof. Input device 112 may be utilized to make a wager, to control any object, to select one or more pattern gaming options, to obtain data relating to historical payouts, to select a row and/or column to move, to select a row area to move, to select a column area to move, to select a symbol (or image) to move, to modify electronic gaming device 100 (e.g., change sound level, configuration, font, language, etc.), to select a movie or song, to select live multi-media streams, to request services (e.g., drinks, slot attendant, manager, etc.), to select two-dimensional (“2D”) game play, to select three-dimensional (“3D”) game play, to select both two-dimensional and three-dimensional game play, to change the orientation of games in a three-dimensional space, to move a symbol (e.g., wild, multiplier, etc.), and/or any combination thereof. These selections may occur via any other input device (e.g., a touch screen, voice commands, etc.). Input device 112 may be any control panel.

Credit device 114 may be utilized to collect monies and distribute monies (e.g., cash, vouchers, etc.). Credit device 114 may interface with a mobile device to electronically transmit money and/or credits. Credit device 114 may interface with a player's card to exchange player points.

Device interface 116 may be utilized to interface electronic gaming device 100 to a bonus game device, a local area progressive controller, a wide area progressive controller, a progressive sign controller, a peripheral display device, signage, a promotional device, network components, a local network, a wide area network, remote access equipment, a slot monitoring system, a slot player tracking system, the Internet, a server, and/or any combination thereof.

Device interface 116 may be utilized to connect a player to electronic gaming device 100 through a mobile device, card, keypad, identification device 118, and/or any combination thereof. Device interface 116 may include a docking station by which a mobile device is plugged into electronic gaming machine 100. Device interface 116 may include an over the air connection by which a mobile device is connected to electronic gaming machine 100 (e.g., Bluetooth, Near Field technology, and/or Wi-Fi technology). Device interface 116 may include a connection to identification device 118.

Identification device 118 may be utilized to determine an identity of a player. Based on information obtained by identification device 118, electronic gaming device 100 may be reconfigured. For example, the language, sound level, music, placement of multi-media streams, one or more game functionalities (e.g., game type 1, game type 2, game type 3, etc.) may be presented, a repeat payline gaming option may be presented, a pattern gaming option may be presented, historical gaming data may be presented, a row rearrangement option may be presented, a column rearrangement option may be presented, a row area rearrangement option may be presented, a column area rearrangement option may be presented, a two-dimensional gaming option may be presented, a three-dimensional gaming option may be presented, and/or the placement of gaming options may be modified based on player preference data. For example, the player may only want to play games that include pattern gaming options only. Therefore, only games which include pattern gaming options would be presented to the player. In another example, the player may only want to play games that include historical information relating to game play. Therefore, only games which include historical gaming data would be presented to the player. These examples may be combined.

Identification device 118 may utilize biometrics (e.g., thumb print, retinal scan, or other biometric). Identification device 118 may include a card entry slot into input device 112. Identification device 118 may include a keypad with an assigned pin number for verification. Identification device 118 may include multiple layers of identification for added security. For example, a player could be required to enter a player tracking card, and/or a pin number, and/or a thumb print, and/or any combination thereof. Based on information obtained by identification device 118, electronic gaming device 100 may be reconfigured. For example, the language, sound level, music, placement of video streams, placement of images, and the placement of gaming options utilized may be modified based on a player's preference data. For example, a player may have selected baseball under the sporting event preferences; electronic gaming device 100 will then automatically display the current baseball game onto side display screen 108 and/or an alternate display screen as set in the player's options.

First display screen 102 may be a liquid crystal display (“LCD”), a cathode ray tube display (“CRT”), organic light-emitting diode display (“OLED”), plasma display panel (“PDP”), electroluminescent display (“ELD”), a light-emitting diode display (“LED”), or any other display technology. First display screen 102 may be used for displaying primary games or secondary (bonus) games, to display one or more warnings relating to game security, advertising, player attractions, electronic gaming device 100 configuration parameters and settings, game history, accounting meters, events, alarms, and/or any combination thereof. Second display screen 104, third display screen 106, side display screen 108, and any other screens may utilize the same technology as first display screen 102 and/or any combination of technologies.

First display screen 102 may also be virtually combined with second display screen 104. Likewise second display screen 104 may also be virtually combined with third display screen 106. First display screen 102 may be virtually combined with both second display screen 104 and third display screen 106. Any combination thereof may be formed.

For example, a single large image could be partially displayed on second display screen 104 and partially displayed on third display screen 106, so that when both display screens are put together they complete one image. Electronic gaming device 100 may stream or play prerecorded multi-media data, which may be displayed on any display combination.

One or more cameras 120 and/or one or more sensors 122 may be utilized as one or more depth image sensing devices, which may be located in various locations, including but not limited to, above the base display, above second display, in one or more locations on gaming cabinet front, on a side of the gaming cabinet other than gaming cabinet front, and/or any other location.

In one embodiment, electronic gaming device 100 may not include separate one or more input devices, but instead may only utilize one or more depth image sensing devices. In another embodiment, a player may utilize one or more input devices and/or may utilize gestures that electronic gaming device 100, via one or more depth image sensing devices, recognizes in order to make inputs for a play of a game. A player may interact with electronic gaming device 100 via one or more depth image sensing devices for a plurality of various player inputs.

In one embodiment, one or more depth image sensing devices may include at least two similar devices. For example, each of the at least two similar devices may independently sense depth and/or image of a scene. In another example, such similar depth image sensing devices may then communicate information to one or more processors, which may utilize the information from each of the similar depth image sensing devices to determine the relative depth of an image from a captured scene.

In another embodiment, one or more depth image sensing devices may include at least two different devices. For example, and discussed in more detail below, one of the at least two different devices may be an active device and/or one of the at least two different devices may be a passive device. In one example, such an active device may generate a wave of measurable energy (e.g., light, radio, etc.). In another example, such a passive device may be able to detect reflected waves generated by such an active device. In another example, such an active device and such a passive device may each communicate data related to their respective activity to a processor, and such processor may translate such data in order to determine the depth and/or image of a scene occurring near electronic gaming device 100.

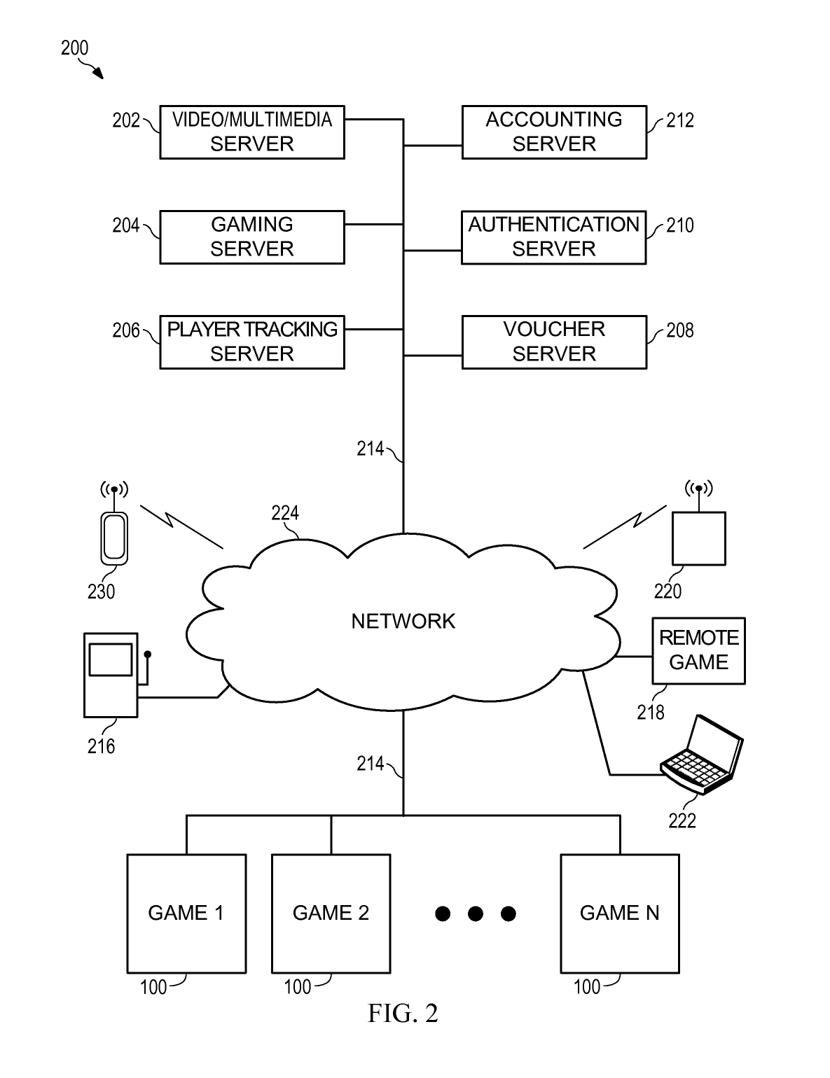

In FIG. 2, an electronic gaming system 200 is shown. Electronic gaming system 200 may include a video/multimedia server 202, a gaming server 204, a player tracking server 206, a voucher server 208, an authentication server 210, and an accounting server 212.

Electronic gaming system 200 may include video/multimedia server 202, which may be coupled to network 224 via a network link 214. Network 224 may be the Internet, a private network, and/or a network cloud. One or more video streams may be received at video/multimedia server 202 from other electronic gaming devices 100. Video/multimedia server 202 may transmit one or more of these video streams to a mobile phone 230, electronic gaming device 100, a remote electronic gaming device at a different location in the same property 216, a remote electronic gaming device at a different location 218, a laptop 222, and/or any other remote electronic device 220. Video/multimedia server 202 may transmit these video streams via network link 214 and/or network 224.

For example, a remote gaming device at the same location may be utilized at a casino with multiple casino floors, a casino that allows wagering activities to take place from the hotel room, a casino that may allow wagering activities to take place from the pool area, etc. In another example, the remote devices may be at another location via a progressive link to another casino, and/or a link within a casino corporation that owns numerous casinos (e.g., MGM, Caesars, etc.).

Gaming server 204 may generate gaming outcomes. Gaming server 204 may provide electronic gaming device 100 with game play content. Gaming server 204 may provide electronic gaming device 100 with game play math and/or outcomes. Gaming server 204 may provide one or more of a payout functionality, a game play functionality, a game play evaluation functionality, other game functionality, and/or any other virtual game functionality.

Player tracking server 206 may track a player's betting activity, a player's preferences (e.g., language, font, sound level, drinks, etc.). Based on data obtained by player tracking server 206, a player may be eligible for gaming rewards (e.g., free play), promotions, and/or other awards (e.g., complimentary food, drinks, lodging, concerts, etc.).

Voucher server 208 may generate a voucher, which may include data relating to gaming. Further, the voucher may include payline structure option selections. In addition, the voucher may include game play data (or similar game play data), repeat payline data, pattern data, historical payout data, column data, row data, and/or symbols that were modified.

Authentication server 210 may determine the validity of vouchers, player's identity, and/or an outcome for a gaming event.

Accounting server 212 may compile, track, and/or monitor cash flows, voucher transactions, winning vouchers, losing vouchers, and/or other transaction data. Transaction data may include the number of wagers, the size of these wagers, the date and time for these wagers, the identity of the players making these wagers, and/or the frequency of the wagers. Accounting server 212 may generate tax information relating to these wagers. Accounting server 212 may generate profit/loss reports for players' tracked outcomes.

Network connection 214 may be used for communication between dedicated servers, thin clients, thick clients, back-office accounting systems, etc.

Laptop computer 222 and/or any other electronic devices (e.g., mobile phone 230, electronic gaming device 100, etc.) may be used for downloading new gaming device applications or gaming device related firmware through remote access.

Laptop computer 222 and/or any other electronic device (e.g., mobile phone 230, electronic gaming device 100, etc.) may be used for uploading accounting information (e.g., cashable credits, non-cashable credits, coin in, coin out, bill in, voucher in, voucher out, etc.).

Network 224 may be a local area network, a casino premises network, a wide area network, a virtual private network, an enterprise private network, the Internet, or any combination thereof. Hardware components, such as network interface cards, repeaters and hubs, bridges, switches, routers, firewalls, or any combination thereof may also be part of network 224.

A statistics server may be used to maintain data relating to historical game play for one or more electronic gaming devices 100. This historical data may include winning amounts, winning data (e.g., person, sex, age, time on machine, amount of spins before winning event occurred, etc.), fastest winning event reoccurrence, longest winning event reoccurrence, average frequencies of winning events, average winning amounts, highest winning amount, lowest winning amount, locations for winning events, winning event dates, winning machines, winning game themes, and/or any other data relating to game play.

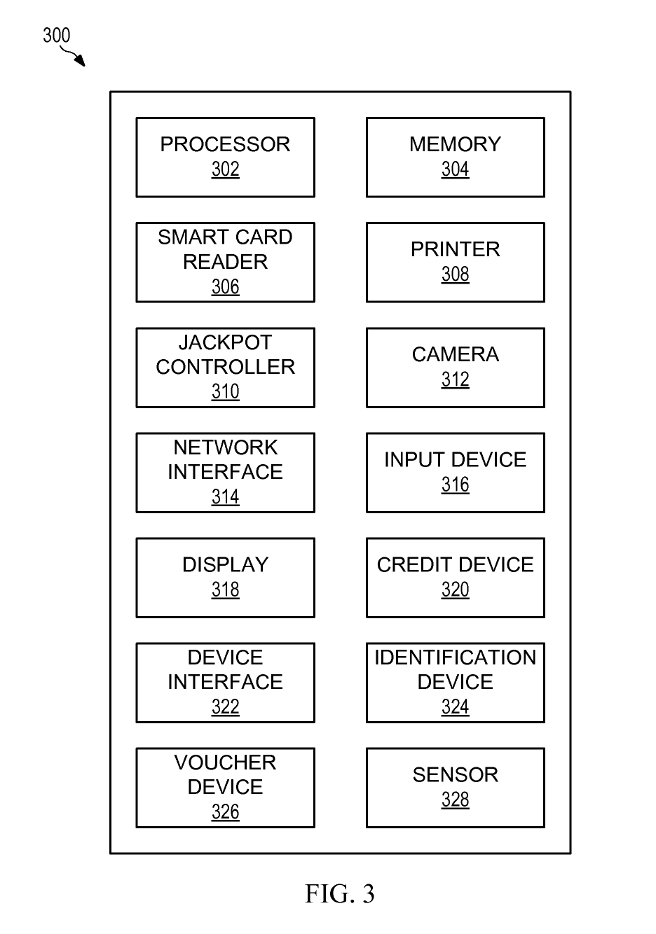

FIG. 3 shows a block diagram 300 of electronic gaming device 100. Electronic gaming device 100 may include a processor 302, a memory 304, a smart card reader 306, a printer 308, a jackpot controller 310, a camera 312, a network interface 314, an input device 316, a display 318, a credit device 320, a device interface 322, an identification device 324, and a voucher device 326.

Processor 302 may execute program instructions of memory 304 and use memory 304 for data storage. Processor 302 may also include a numeric co-processor, or a graphics processing unit (or units) for accelerated video encoding and decoding, and/or any combination thereof.

Processor 302 may include communication interfaces for communicating with electronic gaming device 100, electronic gaming system 200, and user interfaces to enable communication with all gaming elements. For example, processor 302 may interface with memory 304 to access a player's mobile device through device interface 322 to display contents onto display 318. Processor 302 may generate a voucher based on a wager confirmation, which may be received by an input device, a server, a mobile device, and/or any combination thereof. A voucher device may generate, print, transmit, or receive a voucher. Memory 304 may include communication interfaces for communicating with electronic gaming device 100, electronic gaming system 200, and user interfaces to enable communication with all gaming elements. For example, the information stored on memory 304 may be printed out onto a voucher by printer 308. Videos or pictures captured by camera 312 may be saved and stored on memory 304. Memory 304 may include a confirmation module, which may authenticate a value of a voucher and/or the validity of the voucher. Processor 302 may determine the value of the voucher based on generated voucher data and data in the confirmation module. Electronic gaming device 100 may include a player preference input device. The player preference input device may modify a game configuration. The modification may be based on data from the identification device.

Memory 304 may be non-volatile semiconductor memory, such as read-only memory (“ROM”), erasable programmable read-only memory (“EPROM”), electrically erasable programmable read-only memory (“EEPROM”), flash memory (“NVRAM”), Nano-RAM (e.g., carbon nanotube random access memory), and/or any combination thereof.

Memory 304 may also be volatile semiconductor memory such as, dynamic random access memory (“DRAM”), static random access memory (“SRAM”), and/or any combination thereof.

Memory 304 may also be a data storage device, such as a hard disk drive, an optical disk drive such as, CD, DVD, Blu-ray, a solid state drive, a memory stick, a CompactFlash card, a USB flash drive, a Multi-media Card, an xD-Picture Card, and/or any combination thereof.

Memory 304 may be used to store read-only program instructions for execution by processor 302, for the read-write storage for global variables and static variables, read-write storage for uninitialized data, read-write storage for dynamically allocated memory, for the read-write storage of the data structure known as “the stack,” and/or any combination thereof.

Memory 304 may be used to store the read-only paytable information for which symbol combinations on a given payline that result in a win (e.g., payout) which are established for games of chance, such as slot games and video poker.

Memory 304 may be used to store accounting information (e.g., cashable electronic promotion in, non-cashable electronic promotion out, coin in, coin out, bill in, voucher in, voucher out, electronic funds transfer in, etc.).

Memory 304 may be used to record error conditions on an electronic gaming device 100, such as door open, coin jam, ticket print failure, ticket (e.g., paper) jam, program error, reel tilt, etc., and/or any combination thereof.

Memory 304 may also be used to record the complete history for the most recent game played, plus some number of prior games as may be determined by the regulating authority.

Smart card reader 306 may allow electronic gaming device 100 to access and read information provided by the player or technician, which may be used for setting the player preferences and/or providing maintenance information. For example, smart card reader 306 may provide an interface between a smart card (inserted by the player) and identification device 324 to verify the identity of a player.

Printer 308 may be used for printing slot machine payout receipts, slot machine wagering vouchers, non-gaming coupons, slot machine coupons (e.g., a wagering instrument with a fixed waging value that can only be used for non-cashable credits), drink tokens, comps, and/or any combination thereof.

Electronic gaming device 100 may include a jackpot controller 310, which may allow electronic gaming device 100 to interface with other electronic gaming devices either directly or through electronic gaming system 200 to accumulate a shared jackpot.

Camera 312 may allow electronic gaming device 100 to take images of a player or a player's surroundings. For example, when a player sits down at the machine their picture may be taken to include his or her image into the game play. A picture of a player may be an actual image as taken by camera 312. A picture of a player may be a computerized caricature of the image taken by camera 312. The image obtained by camera 312 may be used in connection with identification device 324 using facial recognition. Camera 312 may allow electronic gaming device 100 to record video. The video may be stored on memory 304 or stored remotely via electronic gaming system 200. Videos obtained by camera 312 may then be used as part of game play, or may be used for security purposes. For example, a camera located on electronic gaming device 100 may capture videos of a potential illegal activity (e.g., tampering with the machine, crime in the vicinity, underage players, etc.).

Network interface 314 may allow electronic gaming device 100 to communicate with video/multimedia server 202, gaming server 204, player tracking server 206, voucher server 208, authentication server 210, and/or accounting server 212.

Input device 316 may be mechanical buttons, electronic buttons, a touch screen, and/or any combination thereof. Input device 316 may be utilized to make a wager, to select one or more game elements, to select one or more gaming options, to make an offer to buy or sell a voucher, to determine a voucher's worth, to cash in a voucher, to modify electronic gaming device 100 (e.g., change sound level, configuration, font, language, etc.), to select a movie or music, to select live video streams (e.g., sporting event 1, sporting event 2, sporting event 3), to request services (e.g., drinks, manager, etc.), and/or any combination thereof.

Display 318 may show video streams from one or more content sources. Display 318 may encompass first display screen 102, second display screen 104, third display screen 106, side display screen 108, and/or another screen used for displaying video content.

Credit device 320 may be utilized to collect monies and distribute monies (e.g., cash, vouchers, etc.). Credit device 320 may interface with processor 302 to allow game play to take place. Processor 302 may determine any payouts, display configurations, animation, and/or any other functions associated with game play. Credit device 320 may interface with display 318 to display the amount of available credits for the player to use for wagering purposes. Credit device 320 may interface via device interface 322 with a mobile device to electronically transmit money and/or credits. Credit device 320 may interface with a player's pre-established account, which may be stored on electronic gaming system 200, to electronically transmit money and/or credit. For example, a player may have a credit card or other mag-stripe card on file with the location for which money and/or credits can be directly applied when the player is done. Credit device 320 may interface with a player's card to exchange player points.

Electronic gaming device 100 may include a device interface 322 that a user may employ with his or her mobile device (e.g., smart phone) to receive information from and/or transmit information to electronic gaming device 100 (e.g., watch a movie, listen to music, obtain verbal betting options, verify identification, transmit credits, etc.).

Identification device 324 may be utilized to allow electronic gaming device 100 to determine an identity of a player. Based on information obtained by identification device 324, electronic gaming device 100 may be reconfigured. For example, the language, sound level, music, placement of video streams, placement of images, placement of gaming options, and/or the tables utilized may be modified based on player preference data.

For example, a player may have selected a specific baseball team (e.g., Atlanta Braves) under the sporting event preferences, the electronic gaming device 100 will then automatically (or via player input) display the current baseball game (e.g., Atlanta Braves vs. Philadelphia Phillies) onto side display screen 108 and/or an alternate display screen as set in the player's options.

A voucher device 326 may generate, print, transmit, or receive a voucher. The voucher may represent a wagering option, a wagering structure, a wagering timeline, a value of wager, a payout potential, a payout, and/or any other wagering data. A voucher may represent an award, which may be used at other locations inside of the gaming establishment. For example, the voucher may be a coupon for the local buffet or a concert ticket.

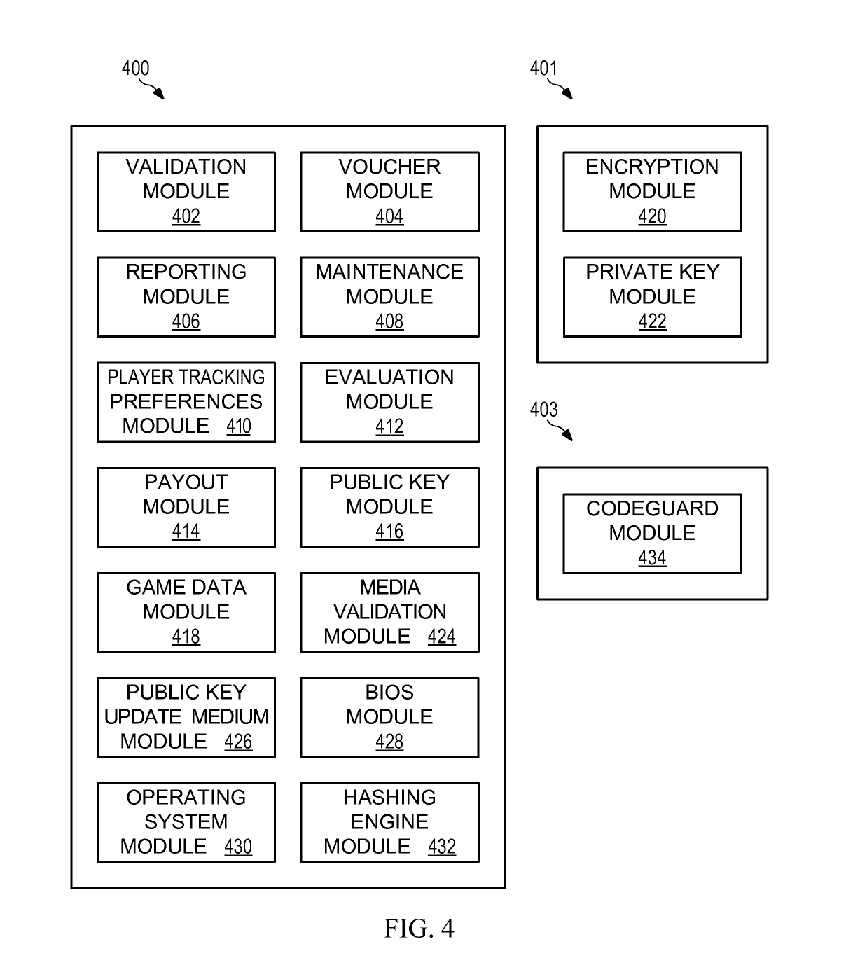

FIG. 4 shows a block diagram of memory 304, which includes various modules. Memory 304 may include a validation module 402, a voucher module 404, a reporting module 406, a maintenance module 408, a player tracking preferences module 410, an evaluation module 412, a payout module 414, a public key module 416, a game data module 418, a media validation module 424, a public key update medium module 426, a BIOS module 428, an operating system module 430, and a hashing engine module 432. Further an encryption module 420, a private key module 422, and/or a CodeGuard module 434 may interact with one or more elements of memory 304.

Validation module 402 may utilize data received from voucher device 326 to confirm the validity of the voucher.

Voucher module 404 may store data relating to generated vouchers, redeemed vouchers, bought vouchers, and/or sold vouchers.

Reporting module 406 may generate reports related to a performance of electronic gaming device 100, electronic gaming system 200, video streams, gaming objects, credit device 114, and/or identification device 118.

Maintenance module 408 may track any maintenance that is implemented on electronic gaming device 100 and/or electronic gaming system 200. Maintenance module 408 may schedule preventative maintenance and/or request a service call based on a device error.

Player tracking preferences module 410 may compile and track data associated with a player's preferences.

Evaluation module 412 may evaluate one or more outcomes for one or more events relating to game play.

Payout module 414 may determine one or more payouts which may relate to one or more inputs received from the player, electronic gaming device 100, and/or electronic gaming system 200.

Public key module 416 may be utilized to schedule software task (e.g., every 500 milliseconds) whose purpose is to check the validity of Public Key 510 (e.g., by calculating a checksum for Public Key 510 and comparing it with a previously calculated value (e.g., at the time the Public Key 510 was originally assigned/stored) that is separately stored (perhaps in Game Data 515 and/or in EEROM on the motherboard or in RAM 540)). If a discrepancy is discovered, it could then trigger a “System Error.” Public key module 416 may be a decryption module (e.g., 1345, 1514, and 1606). Public key module 416 may be checksum calculations (e.g., CRC-16 or CRC-32, which stands for Cyclic Redundancy—1115 and 1220).

Game data module 418 may include data associated with the game and/or game play. This data may be stored in read-only and read/write memory devices. One example of “game data” is data that has to survive a power-hit (e.g., credits on the machine, so this value has to be stored in non-volatile memory (such as BATRAM)).

Encryption module 420 may include data relating to one or more encryption process and/or procedures. Private key module 422 may include data relating to the private key. Media validation module 424 may validate one or more devices and/or elements (e.g., Game and Assets, etc.). In another example, BIOS extension 1115 may also validate one or more devices and/or elements. Public key update medium module 426 may include data entirely contained within “Sector 0”. In one embodiment, “Sector 0” may not adhere to the traditional first sector format/layout-rather; it is a custom block of 512 (or fewer) bytes intended for this specific purpose. Since the encrypted public key may be entirely contained within this 512 bytes, there may be no need for a partition entry/table-and the “data partition” may be utilized for other purposes.

Further, PKUM, in another embodiment, one in which the Public Key Update data will not entirely fit within the 512 bytes of the first sector may follow the traditional first sector format/layout, and “Partition Entry #1” serves the role of their explicit/separate “Partition Table” for locating the Data Partition containing the Public Key. (The vast majority of data partition will in fact may be unused since the Public Key Update data may be quite tiny in size by comparison-at most one, two, or possibly four sectors (2,048 bytes) versus about 1,953,125 sectors for a 1 GB compact flash.

In another example, the module may be responsible for reading the compact flash, validating the Public Key Update data, and/or writing it to the BATRAM/SRAM 510. BIOS module 428 may be a Basic Input/Output System. In one example, a read-only-memory and/or Flash (programmable) memory chip on the motherboard may contain a set of microprocessor instructions for Power-On-Self-Test (“POST”), initializing input and output hardware components, and loading an operating system and/or other program from a mass storage device (e.g., compact flash, hard disk, CD drive, diskette drive, or USB drive). Upon reset and/or power-on, the microprocessor outputs a preset memory address (known as its “reset vector”); located at this address is an instruction to “jump” to the BIOS entry point, upon which the microprocessor will begin executing the BIOS code.

In another example, one of the things the BIOS does is called the Power-On-Self-Test (“POST”), which initializes and tests various parts of the computer (e.g., it's own checksum; video card; RAM; keyboard; PCI card(s); etc.). In another example, the BIOS is programmed to boot an operating system from a location (e.g., diskette, hard drive, CD-ROM, USB, and/or a network). This may be user-configurable and/or fixed. In another example, the BIOS does not understand file systems (such as FAT, NTFS, ext4, etc.)—it only knows how to read the first sector on a mass storage device. The first sector (“Sector 0”) is typically 512 bytes and is known as the Master Boot Record (“MBR”) and may contain three sections; (1) a tiny (typically 446 bytes) bootstrapping program at the start of the MBR; (2) a “partition table” for the mass storage device; and (3) a MBR “signature”.

The bootstrapping program at the start of the MBR could be a DOS loader, a Windows loader, a Linux loader, etc. Unlike the MBR bootstrap code, the MBR's partition table is standardized. In various example, reference numbers various devices and/or modules may include information stored in an active partition entry may be needed to locate their Media Signature, and to calculate the hash over a start/stop range (Alternatively they may elect to “hard-code” the sector(s) in the MBR bootstrap code). The BIOS and BIOS extension 1315 has to access by sector (and/or by CHS-cylinder/head/sector).

This bootstrapping program at the start of the MBR may be a first stage-due to its size; the code in the MBR does just enough to load another sector from disk that contains additional bootstrap code. This sector might by the boot sector for a partition, but could also be a sector that was hard-coded into the MBR bootstrap code when the MBR was installed. The additional MBR bootstrap code just loaded may then read a file containing the second stage of the boot loader. It then (optionally) reads a boot configuration file, either presenting choices to the user and/or simply goes ahead and loads the kernel/operating system. At this point the boot loader needs to load kernel; it must know about file systems to read the kernel file from the disk. It reads the monolithic, contiguous file containing the kernel into memory and then jumps to the kernel's entry point.

Operating system module 430—once loaded and started may further initialize the EGM hardware and then load its “init” program, which starts the system configuration. The Media Validator (“MeV”) may be invoked at the end of the system configuration phase.

Hashing engine module 432 may be utilized in combination with MeV and/or to validate one or more elements. The hashing may be implemented in accordance with FIPS 180-4. In one example, once the Public Key Module 416 has decrypted the Media Signature to reveal a start location and a stop location, the method may be implemented. During the hashing process, the start location, the direction to go, and when to stop may be needed. For example, the start location as being location 0 of sector 0 (each sector is 512 bytes). Blocks of bytes are consumed by the hash algorithm in increasing byte/sector order until the stop location (inclusive) is reached. “Padding” is added at the end as needed to fulfill the m-bit block size of the hash algorithm.

In one example, a sector size of 512 bytes may be an even multiple of several hash algorithms (SHA-1 for example). In this example, the “stop location” may be sector number 1,123,456 and in this sector only three bytes by be utilized-then they must zero-fill (and/or any other method) to “pad” the entire sector. In this example, this may be because the granularity of a start location and a stop location is at a sector level—i.e., 512 bytes-and not at a byte level.

In one example, the process of “signing” a read-only-memory (“ROM”) integrated circuit, a Compact Flash (“CF”) card, a hard disk, and/or any other digital mass storage device may include the signer enters a room with controlled (restricted) access. In one example, for security purposes, the number of person(s) authorized to access this room may be intentionally small (e.g., one, two, or three persons), and a list of person(s) so authorized may be known (made available) to the gaming control board (e.g., Nevada). The room may be under 24 hour video surveillance.

In one example, a single, “stand alone” PC is present in this room, one without any external network connectivity (wired or wireless, inter- or intranet), and no serial or parallel port connections (e.g., a PC, a keyboard, a video monitor, and a mouse).

In one example, the signer possess a mass storage device (such as: a diskette; a CD-ROM; a USB thumb-drive; etc.) containing the “image” to be signed. The PC is used to read this image and “hash it” (i.e., calculate a SHA-1 for example, SHA meaning “secure hash algorithm”) according to Federal Information Processing Standards (FIPS) publication 180-4 (see http://csrc.nist.gov/publications/fips/fips180-4/fips-180-4.pdf). In the case of SHA-1, this calculation produces a 160-bit (20-byte) hexadecimal number referred to as the “message digest,” which is a unique, condensed representation of the original image.

In one example, the message digest of this image is permanently recorded. Further, this message digest of this image may be made known to the Gaming Control Board (e.g., Nevada, etc.) so they may verify images while in the field. In another example, the message digest—optionally along with other pertinent information (e.g., a start and stop location)—may then be encrypted using an Asymmetric Key Encryption algorithm. In one example, the Private Key is known only to the signer (and it must not leave the PC) while the Public Key may be distributed in the field as part of the Electronic Player System (gaming machines). In one example, at this point the signer may leave the room. Since the PC has no outside connectivity, the encrypted information from step five must somehow be manually conveyed with him, perhaps by diskette or USB thumb-drive. This encrypted “media signature” is then made part of the image (e.g., making it the last-or next to last-sector in the image's medium) before it can be released to QA, Production, and eventually find its way into the field.

CodeGuard module 434 may generate, compile, store, and/or transmit one or more data points relating to a validation process where the validation process is RAM based. CodeGuard module 434 may be implemented as part of the system ROM, as part of the kernel, and/or as part of the loadable kernel module.

In one example, the one or more processors utilized in the gaming device and/or gaming system employs the 64-bit architecture. In one example, the one or more processors may offer a very complex and secure system of memory-management that the kernel utilizes to enforce process security. In one embodiment, the directory files are the files “mmap.c”, “mprotect.c”, “mmremap.c” and “pgtable-generic.c”. These files may be related to handling memory management data structures that are not hardware-specific. For example, a system's architecture may have separate read, write and execute bits to enforce memory protection. Some architectures with separate read, write and execute bits can actually define a page as being execute-only, with no possible way to read code as data. To provide a high level of protection while remaining compatible, the architecture includes the NX bit to the page attributes. This bit can be used to determine that a page is not executable, therefore only allowing reading or writing of data.

In various examples, hardware-provided attributes may determine a memory page accessibility level as follows: 1) User/Supervisor (“U/S”) bit—This bit determines if a page can be accessed by user programs—the Supervisor mode is reserved for the kernel itself (If a page is marked as belonging to supervisor mode, no user-level access is allowed (not even the root user)); 2) Read/Write (“R/W”) bit—This bit determines if a page is read-only or writable—when the processor is in the Supervisor mode (i.e. running kernel code) it ignores this bit, effectively making all pages writable. The exception is when the Write-Protect (“WP”) bit is set, and it is described below; 3) WP bit—This bit controls write access to a page even if the processor is in Supervisor mode—The kernel marks the code pages with this bit set, to protect itself from malicious exploits. This means that even the root user would be unable to write to kernel code pages; and 4) No Execute (“NX”) bit—This bit determines if a page can contain executable code. If set, code execution is not allowed. This prevents malicious stack-overflow type of attacks.

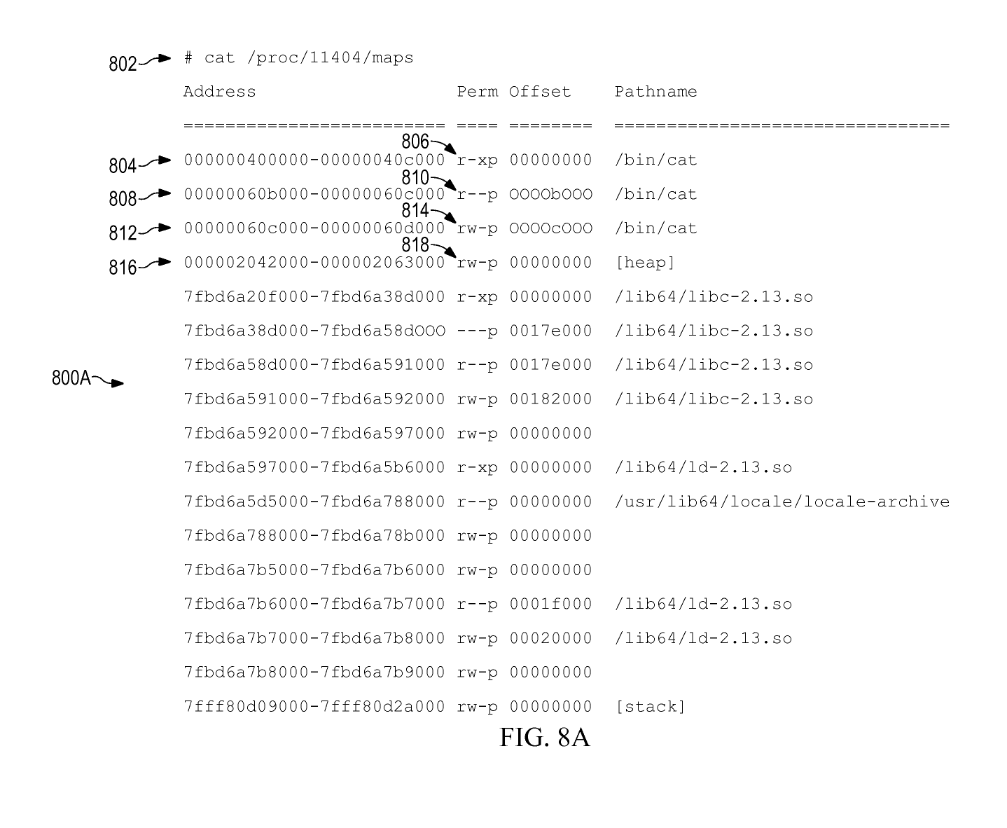

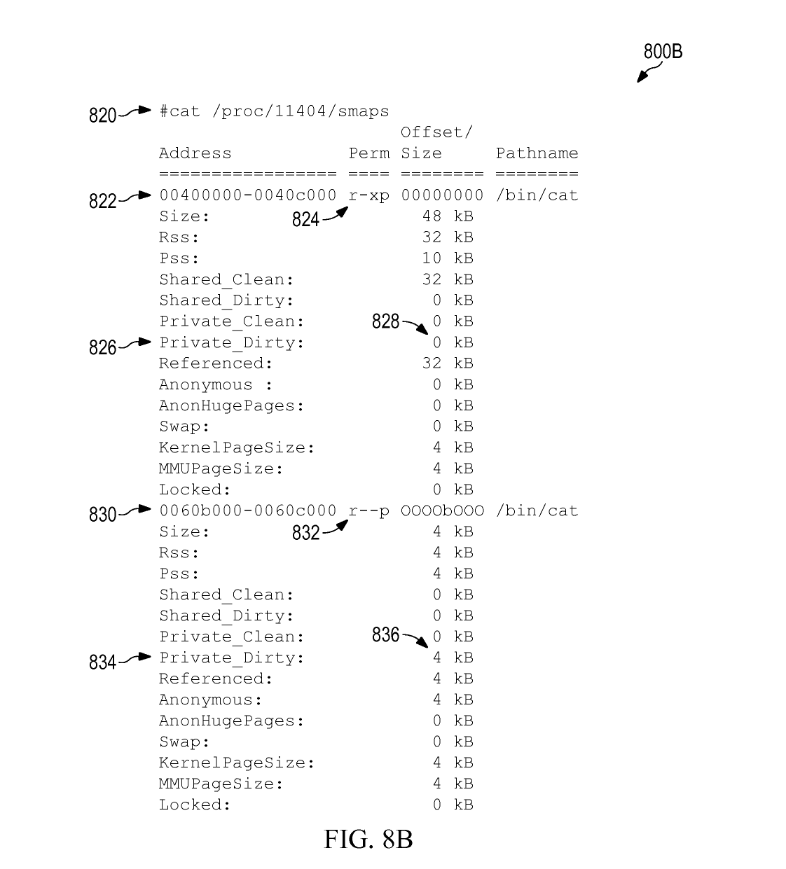

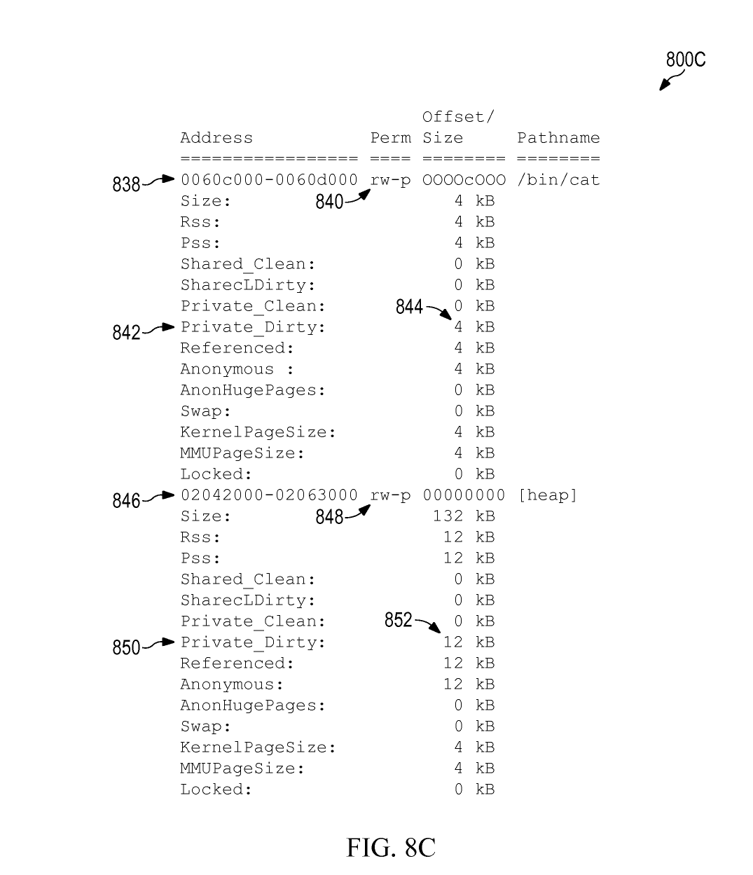

In various examples, the kernel uses the hardware facilities described above to implement the page-protection mechanism. The following access attributes (see FIGS. 8A-8C) are defined for memory pages: 1) “R” for read access (derived from the R/W bit); 2) “W” for write access (derived from the R/W bit); and 3) “X” for execute access (derived from the NX bit). Furthermore, a process may have private (“P”) and shared (“S”) memory pages. The kernel may place a program's “.text” segment (executable code) in a private, read-only executable page. The “.data” segment (constants) is placed in a private, read-only page. The “.bss” segment (uninitialized static variables) is placed in a private, read-write segment. Any additional memory requested by a program through the “malloc( )” call is placed in a private, read-write segment. The shared attribute is mostly used by shared-memory segments for inter-process communication (“IPC”), and they can be of read-only or read-write access.

In another example, the “Dirty” bit may be set to one when a write access is performed on a page. The processor never clears this bit automatically, so the system software can determine if a write has been performed, and clear this bit if necessary (or take preventive action). The kernel may further protect memory pages from malicious access by employing virtual memory management (“VMM”). The VMM maps logical virtual addresses to real physical memory addresses. Before a process starts, a certain amount of physical memory is reserved by the kernel for the VMM. Then this block of memory is mapped to a logical address through the hardware Memory Management Unit (“MMU”), and finally the file that contains the process image is read into this block of memory. When this new process starts, it has no idea of where in the physical memory-map it is executing from. All of its pointers can only access its own virtual address space. If a pointer is loaded with an arbitrary value that is not mapped to the process virtual address space, and then this pointer is used to dereference memory, a page-fault violation will occur and the offending program is terminated. A process can read the /proc/<pid>/maps virtual file provided by the kernel to try to find out its physical to logical address mapping, but the physical address will be useless to the process since it cannot be referenced in any useful way. A malicious user could naively try to read the /proc/<pid>/maps file of another process that belongs to the root user, in order to modify the code there and gain root access. This however is not possible for two reasons: 1) The kernel will enforce user privilege-levels when reading the virtual “/proc” filesystem—Thus a regular user will not be able to see any information about any process that belongs to the root user; and 2) Even if it was possible to read the memory mapping of the root user process by a less privileged user, the physical address information would be useless because of the limitation that the kernel imposes on each process to only be able to use addresses in the virtual address space. The memory security features of the kernel have been discussed above. By using those features in our Electronic Player Systems (“EPS”) we ensure that even if an attacker gains root privilege and starts a malicious program, it cannot change a page of memory belonging to another process (address space separation). Furthermore, the integrity of all processes running in an EPS will be checked by a daemon process (“CodeGuard”) that is started at boot, before the game runs. The job of CodeGuard is to scan the memory descriptors of all active processes and check that there has been no change to any code pages.

Our integrity check consists of periodically checking for access information in the /proc/<pid> facility discussed above. The kernel maintains the state of all page descriptors belonging to a process in the /proc/<pid> interface. Any change to any memory page can be verified by inquiring the “Private_Dirty” status field, which is derived from the “dirty bit” described previously. This field indicates that a memory page has been written to, and by how many bytes. Since a code page is read-only, its “Private_Dirty” field should remain clear during the life-time of any process. This checking ensures that even in the extremely unlikely event where an attacker is successful in writing to a code page, that change will not go unnoticed. In that case, the CodeGuard daemon will terminate the altered process immediately and then halt the system.

In various examples discussed below, one or more procedures may be utilized to ensure media image integrity. To supplement the above mentioned memory security facilities, we are delivering the root file system, and all of the platform code, in a read-only compressed file-system by using the Squash File System (“Squash FS”). Additionally, the media itself will be set to read-only mode whenever possible. Compact Flash media usually offer a read-only switch that can be sealed in place. Squash FS is used to provide an additional security layer: even if an attacker gets root access to an EPS, there is very little damage that can be done. Because the root file-system is read-only, an intruder would not be able to change its contents. The SquashFS file-system is not just marked read-only in the /etc/fstab file, it's truly read-only meaning that there are not even functions to write to it in the kernel. The procedure to generate the root file-system image is the following: a script generates the root file system image, by copying a list of files in a manifest file to a temporary image. When the imaging procedure is completed, the image file is written to the final target media. Once the image is generated, it cannot be modified without breaking its integrity self-check. The /proc/<pid> interface was designed to give an insight into the data structures that the kernel uses for each process, given that user access privilege restrictions are satisfied. The memory paging structures for a given process can be examined in detail. The paging information is refreshed whenever a read request is issued, directly from the registers that control the paging hardware. Thus it can be detected when a certain page has been written to, and allowing for appropriate action to be taken.

As an example, lets launch a process as root, and try to learn some information from it from a regular user account: As root, type the command below, which will launch the CAT command and make it wait for input:

# cat & <Enter>

In a regular user account, type:

$ ps -eflgrep cat

You should see something like:

root 11404 9117 0 15:51 pts/2 00:00:00 cat

Where root is the process' owner ID, and the first number is the process ID. Then from the regular user account let's try to access the paging information from the cat process owned by root:

$ cat /proc/11404/maps

cat: /proc/11404/maps: Permission denied

$cat /proc/11404/smaps

cat: /proc/11404/smaps: Permission denied

As we can see, the kernel does not allow access to paging information without proper access permissions. Now if the root user issues a request for access to the paging data for the above CAT process, the kernel will examine its internal paging data structures and will produce an output that resembles what is shown below (see FIGS. 8A-8C):

# cat /proc/11404/maps

00400000-0040c000 r-xp 00000000 09:0a 2102902

0060b000-0060c000 r--p OOOObOOO 09:0a 2102902

0060c000-0060d000 rw-p OOOOcOOO 09:0a 2102902

/bin/cat

/bin/cat

/bin/cat

02042000-02063000 rw-p 00000000 00:00 0

7fbd6a20f000-7fbd6a38dOOO r-xp 00000000 09:0a 1985116

7fbd6a38d000-7fbd6a58d000---p 0017e000 09:0a 1985116

7fbd6a58d000-7fbd6a591000 r--p 0017e000 09:0a 1985116

7fbd6a591000-7fbd6a592000 rw-p 00182000 09:0a 1985116

7fbd6a592000-7fbd6a597000 rw-p 00000000 00:00 0

7fbd6a597000-7fbd6a5b6000 r-xp 00000000 09:0a 1985105

7fbd6a5d5000-7fbd6a788000 r--p 00000000 09:0a 3293656

7fbd6a788000-7fbd6a78b000 rw-p 00000000 00:00 0

7fbd6a7b5000-7fbd6a7b6000 rw-p 00000000 00:00 0

7fbd6a7b6000-7fbd6a7b7000 r--p 0001f000 09:0a 1985105

7fbd6a7b7000-7fbd6a7b8000 rw-p 00020000 09:0a 1985105

7fbd6a7b8000-7fbd6a7b9000 rw-p 00000000 00:00 0

7fff80d09000-7fff80d2a000 rw-p 00000000 00:00 0

7fff80dc7000-7fff80dc8000 r-xp 00000000 00:00 0

fffffffff600000-ffffffffff601000 r-xp 00000000 00:00 0

[heap]

/lib64/libc-2.13.so

/lib64/libc-2.13.so

/lib64/libc-2.13.so

/lib64/libc-2.13.so

/lib64/Id-2.13.so

/usr/lib64/locale/locale-archive

/lib64/Id-2.13.so

/lib64/Id-2.13.so

[stack]

[vdso]

[vsyscall]

The first line of the output above tells us that the “.code” ELF segment has been loaded into a page that has been marked read-only, executable and private, as the attibute r-xp represents. The second line belongs to the “.data” segment, meaning it contains pre-initialized constants. It's marked as a read-only, private page. The third line belongs to the “.bss” field, and contains room for uninitialized variables. It is marked as read-write and private. The fourth line reflects the “heap” segment, which is memory that has been dynamically allocated by the process. It is marked read-write and private. The remaining lines describe memory pages that belong to shared libraries that the process requires to function. The output that we are mostly interested in however, is only available in another virtual file: /proc/11404/smaps. This file presents a lot more detail about each page:

# cat /proc/11404/smaps

00400000-0040c000 r-xp 00000000 09:0a 2102902

Size: 48 kB

Rss: 32 kB

Pss: 10 kB

Shared_Clean: 32 kB

Shared_Dirty: 0 kB

Private_Clean: 0 kB

Referenced: 32 kB

Anonymous: 0 kB

AnonHugePages: 0 kB

Swap: 0 kB

KernelPageSize: 4 kB

MMUPageSize: 4 kB

Locked: 0 kB

0060b000-0060c000 r--p 0000b000 09:0a 2102902

Size: 4 kB

Rss: 4 kB

Pss: 4 kB

Shared_Clean: o kB

Shared_Dirty: 0 kB

Private_Clean: 0 kB

Private_Dirty: 4 kB

Referenced: 4 kB

Anonymous: 4 kB

/bin/cat

/bin/cat

AnonHugePages: 0 kB

Swap: 0 kB

KernelPageSize: 4 kB

MMUPageSize: 4 kB

Locked: 0 kB

0060c000-0060d000 rw-p OOOOcOOO 09:0a 2102902/bin/cat

Size: 4 kB

Rss: 4 kB

Pss: 4 kB

Shared_Clean: 0 kB

SharecL.Dirty: 0 kB

Private . . . Clean: 0 kB

Private_Dirty: 4 kB

Referenced: 4 kB

Anonymous: 4 kB

AnonHugePages: 0 kB

Swap: 0 kB

KernelPageSize: 4 kB

MMUPageSize: 4 kB

Locked: 0 kB

02042000-02063000 rw-p 00000000 00:00 0 [heap]

Size: 132 kB

Rss: 12 kB

Pss: 12 kB

Shared_Clean: 0 kB

SharecL.Dirty: 0 kB

Private_Clean: 0 kB

Private_Dirty: 12 kB

Referenced: 12 kB

Anonymous: 12 kB

AnonHugePages: 0 kB

Swap: 0 kB

KernelPageSize: 4 kB

MMUPageSize: 4 kB

Locked: 0 kB

In the output above, the first memory page has the r-xp attributes, denoting it as a code page. Its “Private_Dirty” field has OKB, meaning no writes have been detected to that page since it has been loaded from the OS media. The other fields belong to variable segments, and thus have their “Private_Dirty” field set to the amount of data written since the executable image was loaded. The examples above serve to illustrate how the CodeGuard daemon will scan process information from the /proc/<pid> facility to ensure that no modifications to any code page of any process that is running in an EPS will be allowed. The kernel provides all the tools necessary to enforce a high level of process security. In various examples, RAM Protection for electronic gaming systems are discussed. In one example, a method of protecting system memory from accidental or malicious content alteration in an electronic gaming system may use non-ECC motherboards. Some jurisdictions require a memory validation mechanism. For some jurisdictions this requirement can be met by the use of Error-Correcting Code (“ECC”) Memory, which is only effective for correcting hardware errors. Other jurisdictions are more interested in the security aspects of memory manipulation, and can require a digital signature to be calculated for each RAM page. That however, is very processor intensive and can interfere with game play. The motherboard that an electronic gaming device uses may not offer the possibility to implement ECC RAM. Thus, in order to satisfy the jurisdictions that require RAM validation, a software solution to target the detection of accidental and/or malicious memory alteration was required. In one example, a software method of RAM verification that uses facilities available in the kernel, in order to detect malicious or accidental alteration of executable code in the electronic gaming system, which does not use ECC enabled motherboards is disclosed. This method has various benefits, which are at least: 1) utilizing RAM allows for the continuous scanning for malicious or accidental alteration; 2) there is no overhead for calculating signatures on-the-fly; and 3) the media where processes are stored is physically set to read-only, thus offering the verification process an unalterable reference. In these examples, the RAM validation requirement for all jurisdictions can be met without overburdening the processor and without changing the motherboard to use ECC RAM.

In one example, the system and/or device utilizes a kernel in a 64 bit mode (the x86_{—}64 architecture). In this mode, the kernel implements a virtual memory addressing scheme for RAM with process address separation mechanisms for enhanced security. In this virtual-memory environment, memory segments belonging to a process are not addressed by the physical address, but rather by a “virtual” address. The virtual address range that a process can utilize will not collide with those from another process, even if they have identical value. This is possible since the MMU can map the virtual addresses to physical ones using a hardware implemented table look-up method. This mapping makes it very difficult for an attacker to gain privileged access to the system, since the pointers in its process cannot point to the address space of another process. Another protection offered by this architecture is the enforcement of memory attributes. RAM pages are 4 KB long and have several attributes such as read-only and non-executable. These attributes are used to prevent a process from altering read-only memory locations, and to prevent executing data payloads, respectively. Thus it becomes evident that this architecture already offers strong mechanisms to prevent malicious alteration of memory by virtue of hardware safeguards. In order to completely satisfy the requirements of jurisdictions that mandate RAM verification, we must complement the memory protection facilities presented above with a process that continuously scans memory. This process is CodeGuard. The purpose of CodeGuard is to detect accidental or malicious RAM alterations. However, there are limits to what memory areas can be validated efficiently by software. In one example, the method may validate those areas with constant values, like the code (e.g., text in Unix parlance) segment of a process. The memory areas where variables are stored (data segments) are modifiable by nature, and may not be optimal areas for a validation process. Thus, CodeGuard may only scan the parts of RAM that belong to a process code segment, and check that segment against its image on the media where it resides. This method avoids the overhead of calculating a signature for the image of each process, but it only works if the reference media where the code segment images are stored is read-only. That is because an unalterable reference must be available for this verification method to work.

It should be noted that one or more modules may be combined into one module. Further, there may be one evaluation module where the determined payout does not depend on whether there were any wild symbols, scatter symbols, platform based game play, and/or any other specific symbols. Further, any module, device, and/or logic function in electronic gaming device 100 may be present in electronic gaming system 200. In addition, any module, device, and/or logic function in electronic gaming system 200 may be present in electronic gaming device 100.

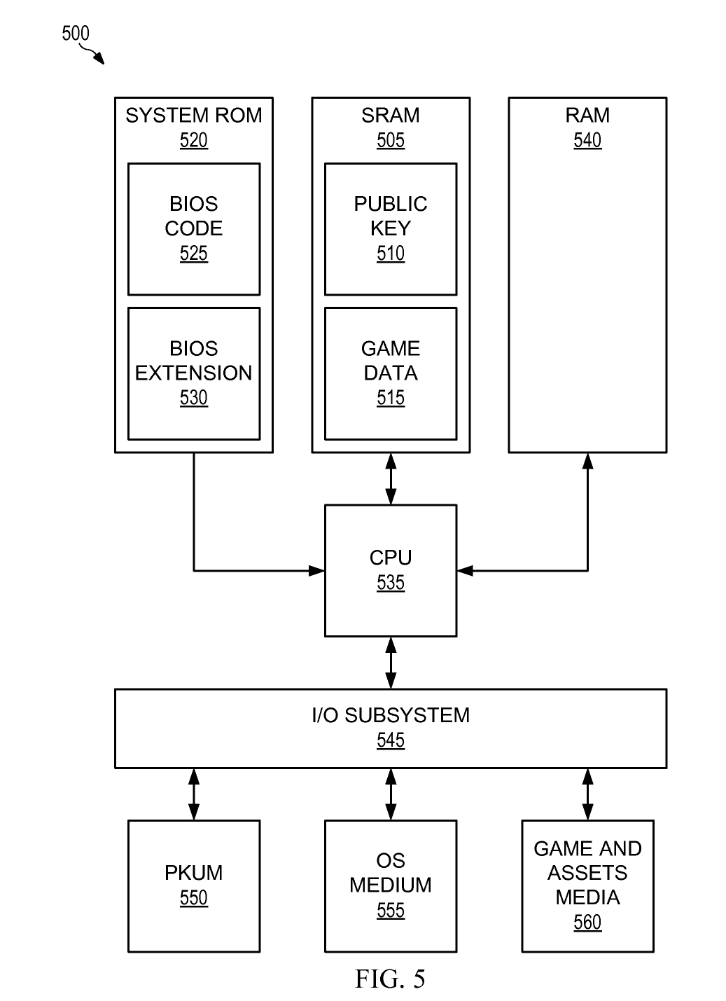

FIG. 5 is a diagram illustration of an exemplary gaming system, according to one embodiment. Specifically, FIG. 5 illustrates components that may be included with a gaming system, generally shown at 500. Gaming system 500 is illustrated as a dashed line as it is contemplated that one or more components illustrated therein may be physically located remote from one or more other components. However, for illustration purposes, exemplary components are illustrated in FIG. 5 as being located within a single enclosure. Further, it should be appreciated that FIG. 5 illustrates various components in a diagrammatic view, and individually identified components may be comprised of several distinct components, and that FIG. 5 is only meant to illustrate a simplified configuration for purposes of explanation.

Gaming system 500 may have one or more central processing units (“CPU”) 535. CPU 535 may include one or more processors. CPU 535 may be hardware, and may be configured to carry out instructions received from one or more memory devices and/or one or more blocks of programs stored on one or more memory devices.

CPU 535 may communicate with a read/write memory device, such as a static random-access memory (“SRAM”) 505. In one embodiment, SRAM 505 may include one or more battery devices which may prevent data corruption due to an occurrence of an out-of-tolerance condition. In one embodiment, SRAM 505 may store public key 510 which may be used, as discussed more below, for media validation. In another embodiment, SRAM 505 may include game data 515. In one example, game data 515 may include persistent game data. In another example, game data 515 may include other persistent data.

CPU 535 may communicate with system Read Only Memory (“ROM”) 520. In one embodiment, system ROM 520 may include Basic Input/Output System (“BIOS”) code 525. In one embodiment, BIOS code 525 may include that the first instructions CPU 535 is configured to execute upon a power on and/or reset event. In one example, BIOS code 525 may include instructions for initializing one or more components of gaming system 500.

System ROM 520 may also store a BIOS extension 530. In one embodiment, BIOS extension 530 may be configured to allow CPU 535 to produce a calculated signature, as discussed more fully below, based on a sector and/or sectors of media used to store data. In one embodiment, it is contemplated that utilization of a BIOS extension 530 for ROM-based media validation may provide particular advantages. For example, an associated motherboard may only allow a limited number of address lines, which may further limit the size of an associated ROM to ROM socket. In another example, such an address space limitation may be further complicated due to a large BIOS code size. In a further example, a file-by-file verification algorithm, which may require file-system logic to be included in BIOS code, may also need additional initialization routines and/or kernels to be included as well, which may greatly increase the associated file size. In one embodiment, sector input/output routines are readily available within BIOS code 525. In a further embodiment, BIOS extension 530 may be comprised of such sector input/output routines. In another embodiment, BIOS extension 530 may be configured to, as discussed more fully below, determine one or more sectors of an operating system medium and the calculation of an associated signature.

CPU 535 may communicate with additional read/write memory devices, such as Random Access Memory (“RAM”) 540. RAM 540 may include event data and/or other data generated and/or used during a play of a particular game.

CPU 535 may also communicate with an Input/Output (“I/O”) subsystem 545. I/O subsystem 545 may manage and/or coordinate communications between CPU 535 and various other components, which may include one or more media devices. I/O subsystem 545 may coordinate activities between CPU 535 and I/O subsystem 545. I/O subsystem 545 may map external I/O processing requirements into the basic functionality of the I/O subsystem 545. I/O subsystem 545 may also manage concurrent processing activities within the I/O subsystem 545 itself.

I/O subsystem 545 may communicate with a Public Key Update Medium (“PKUM”) 550. In one embodiment, and as discussed more fully below, PKUM 550 may include instructions which may be utilized to update public key 510. In another embodiment, PKUM 550 may not be in full-time communication with I/O subsystem 545, but rather, and as discussed more fully below, may be requested to be placed in communication by CPU 535 if it is determined that public key 510 needs to be updated. In one example, the data received and/or transmitted by PKUM 550 may be encrypted. In another example, the data received and/or transmitted by PKUM 550 may not be encrypted. Any of the data transmitted and/or received by any device may be encrypted, may not be encrypted and/or any combination thereof.

In one embodiment, it may be particularly beneficial to store public key 510 on a memory device which more easily allows updating (e.g., SRAM 505) as opposed to another location which may be more difficult to update (e.g., system ROM 520 and/or BIOS code 525). It is contemplated that in this manner, it may be easier to change, update, or otherwise correct the public key. For example, placing PKUM 550 in communication with gaming system 500 may be a quick and easy way to update public key 510, without requiring the replacement of the more complicated and sensitive system ROM 520 and/or BIOS code 525.

I/O subsystem 545 may also communicate with Operating System (“OS”) medium 555, and/or game and assets media 560. I/O subsystem 545 may utilize such communication to facilitate validation of OS medium 555 and/or game and assets media 560.

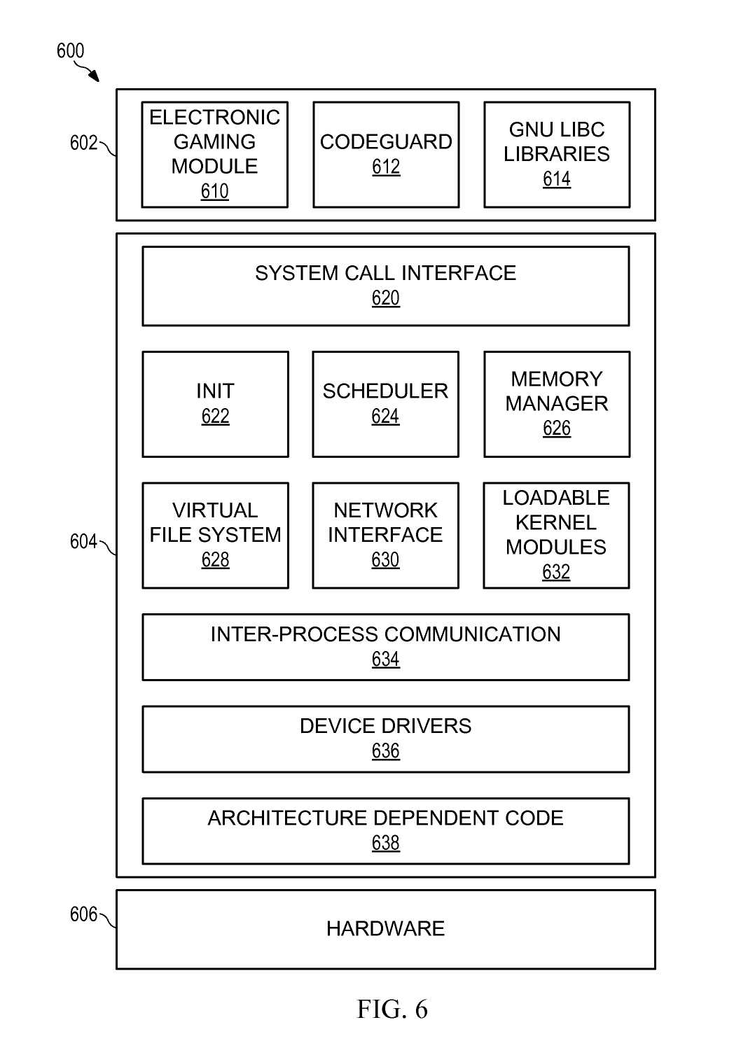

In FIG. 6, another block diagram of an exemplary gaming device 600 is shown, according to one embodiment. Gaming device 600 may include a user space 602, a kernel space 604, and/or a hardware area 606. User space 602 may include an electronic gaming module 610, a CodeGuard module 612, and/or a GNU LIBC Libraries 614. Kernel space 604 may include a system call interface 620, an INIT 622, a scheduler 624, a memory manager 626, a virtual file system 628, a network interface 630, one or more loadable kernel modules 632, an inter-process communication 634, one or more device drivers 636, and/or an architecture dependent code 638.

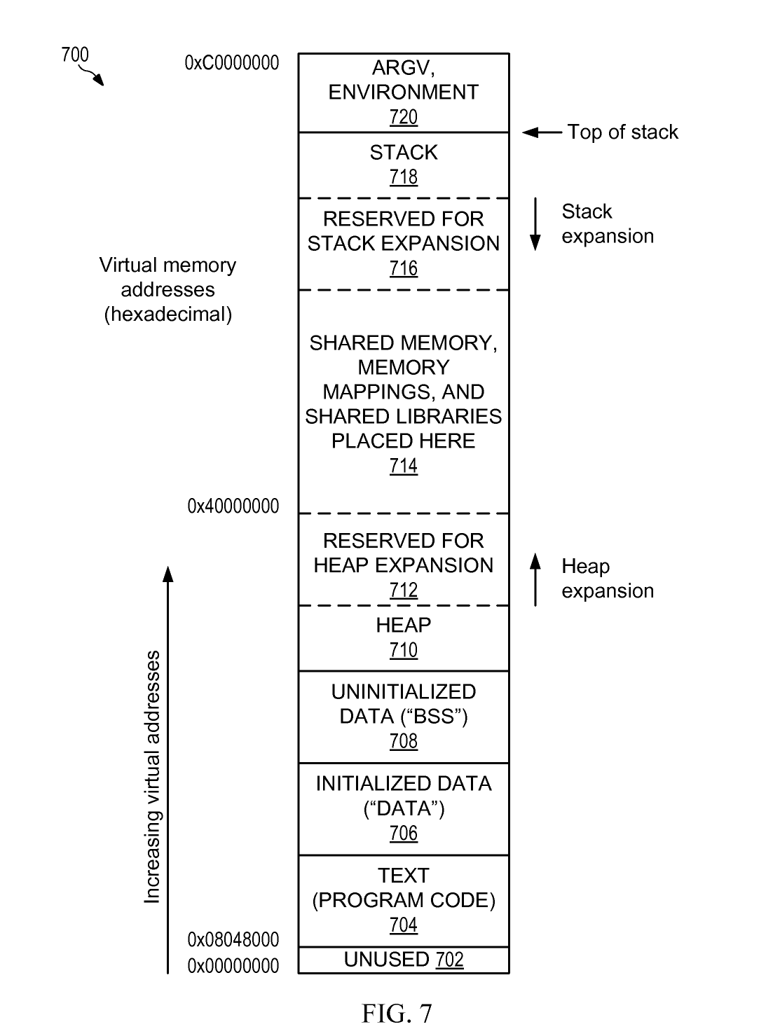

In FIG. 7, a diagram of an exemplary memory layout 700 is shown, according to one embodiment. Memory layout 700 may include an ARGV environment area 720, a stack area 718, a reserved for stack expansion area 716, a shared memory area 714, a reserved for HEAP expansion area 712, a HEAP area 710, a uninitialized data (“BSS”) area 708, an initialized data (“DATA”) area 706, a text (program code) area 704, and an unused area 702.

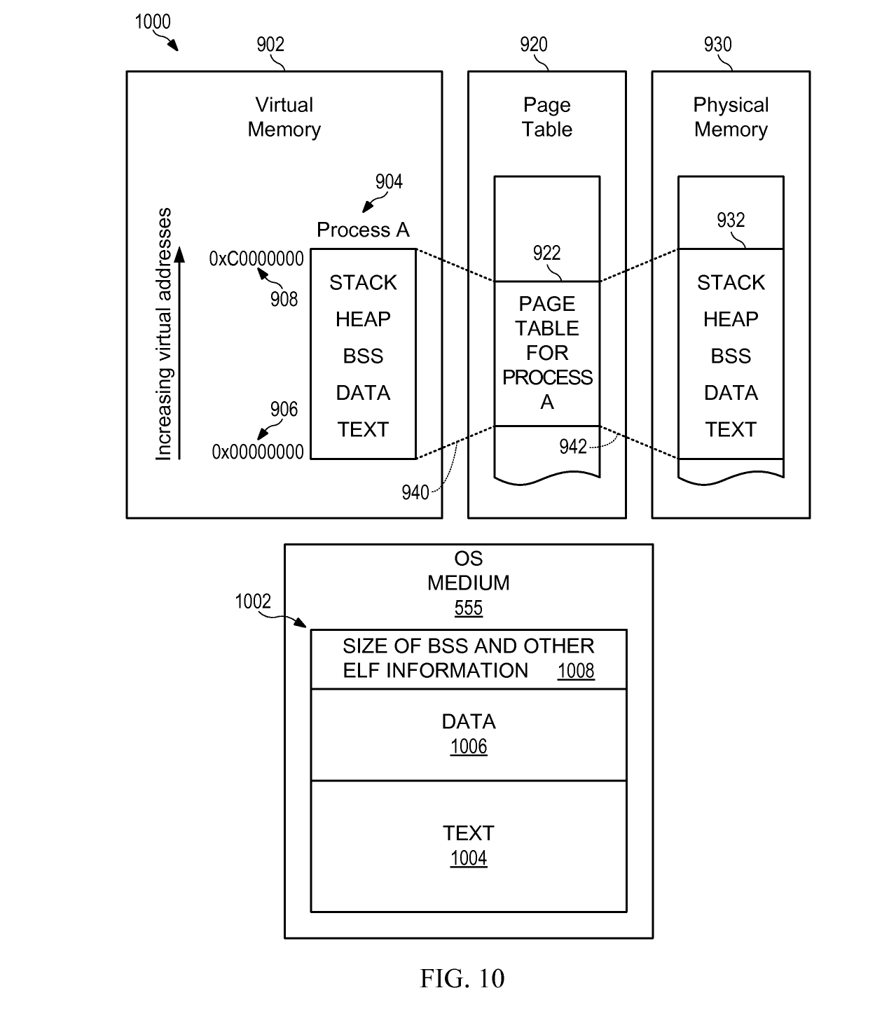

In one example, text area 704 is the read-only program code “read-only” at run-time. Even though text area 704 is loaded into read-write memory (“RAM”), the Kernel/OS/CPU memory manager marks this region of memory as “read-only, executable, private” (“r-xp”—see 806). Thus CodeGuard will scan only the parts of RAM that belong to a process code [TEXT] segment, and check that segment against its image on the media [555 and/or 560] where it resides. Only the TEXT segment can be checked during run-time because data area 706, BSS (“Block Started by Symbol”) 708, HEAP 710, and STACK 718 typically undergo many dynamic changes to their contents while the program is executing (“rw-p” in FIG. 8). The text segment contains the machine-language instructions of the program run by the process. The text segment is made read-only so that a process doesn't accidentally modify its own instructions via a bad pointer value and/or a malicious program running in User Space can't modify it. The initialized data segment contains global and static variables that are explicitly initialized. The values of these variables are read from the executable file when the program is loaded into memory. (See FIG. 10—DATA 1006; both TEXT 1004 and DATA 1006 are copied as-in into memory). The uninitialized data segment contains global and static variables that are not explicitly initialized. Before starting the program, the system initializes all memory in this segment to 0. The main reason for placing global and static variables that are initialized into a separate segment from those that are uninitialized is that, when a program is stored on disk, it is not necessary to allocate space for the uninitialized data. Instead, the executable merely needs to record the location and size required for the uninitialized data segment, and this space is allocated by the program loader at run time. (See FIG. 10—while TEXT and DATA are typically large (hundreds of thousands of bytes—megabytes, 1008 is typically quite small—perhaps 1-3 dozens of bytes. BTW in 1008, “ELF” stands for “Executable and Linkable Format”)).

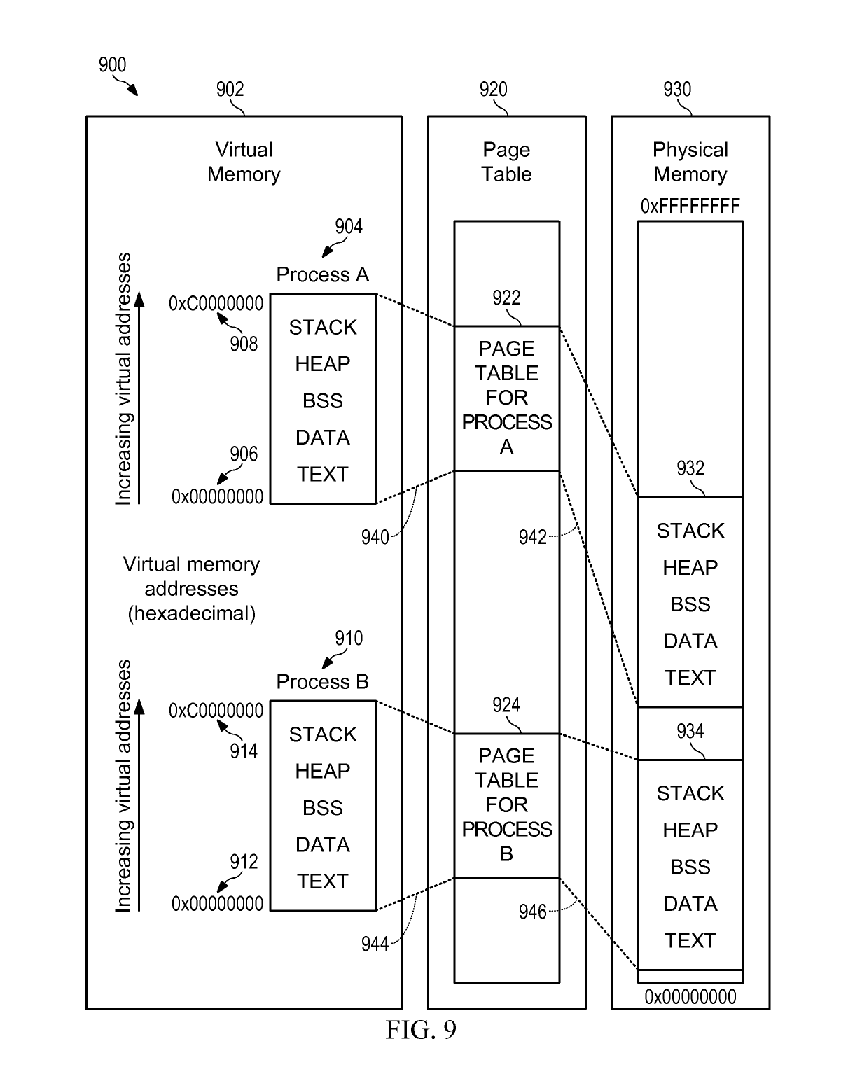

The stack is a dynamically growing and shrinking segment containing stack frames. One stack frame is allocated for each currently called function. A frame stores the function's local variables (so-called automatic variables), arguments, and return values. The heap is an area from which memory (for variables) can be dynamically allocated at run time. The top of the heap is called the program break. Virtual memory management separates the virtual address space of a process from the physical address space of RAM. This provides many advantages: 1) processes are isolated from one another and from the kernel, so that one process can't read or modify the memory of another process of the kernel. This is accomplish by having the page-table entries for each process point to distinct sets of physical pages in RAM (See FIG. 9); and 2) the implementation of memory protection schemes is facilitated; that is, page-table entries can be marked to indicate that the contents of the corresponding pages are readable, writable, executable, or some combination of these protections. Where multiple processes share pages of RAM, it is possible to specify that each process has different protections on the memory; for example, one process might have read-only access to a page, while another has read-write access.

In FIG. 9, an illustration 900 of the interrelationship of two programs is shown, according to one embodiment. In this example, illustration 900 may include a virtual memory area 902, a page table area 920, and a physical memory area 930. Virtual memory area 902 may include a Process A 904 and a Process B 910. Process A 904 may include one or more virtual addresses (e.g., 906, 908, etc.). Process B 910 may include one or more virtual addresses (e.g., 912, 914, etc.). In one example, Process A 904 may be mapped via a first page table for Process A 922 to a first physical memory area 932, which is represented by a first mapping function 940 and a second mapping function 942. In one example, Process B 910 may be mapped via a second page table for Process B 924 to a second physical memory area 934, which is represented by a third mapping function 944 and a fourth mapping function 946.

In FIG. 10, another illustration 1000 of an electronic gaming system is shown, according to one embodiment. Illustration 1000 may include virtual memory area 902, page table area 920, and physical memory area 930. In one example, Process A 904 may be mapped via first page table for Process A 922 to first physical memory area 932, which is represented by first mapping function 940 and second mapping function 942. In one example, the method shows the two key components of the algorithm: the TEXT segment residing on a read-only mass storage device (e.g., 555) and the TEXT segment in memory. Initially the kernel's program loaded transfer the executable program from 555 to memory, creating the memory layout of a process (FIG. 7; FIG. 10 as 904 and 932). The algorithm may compare the TEXT segment on 555 with the TEXT segment in memory 932 via 922 and 904.

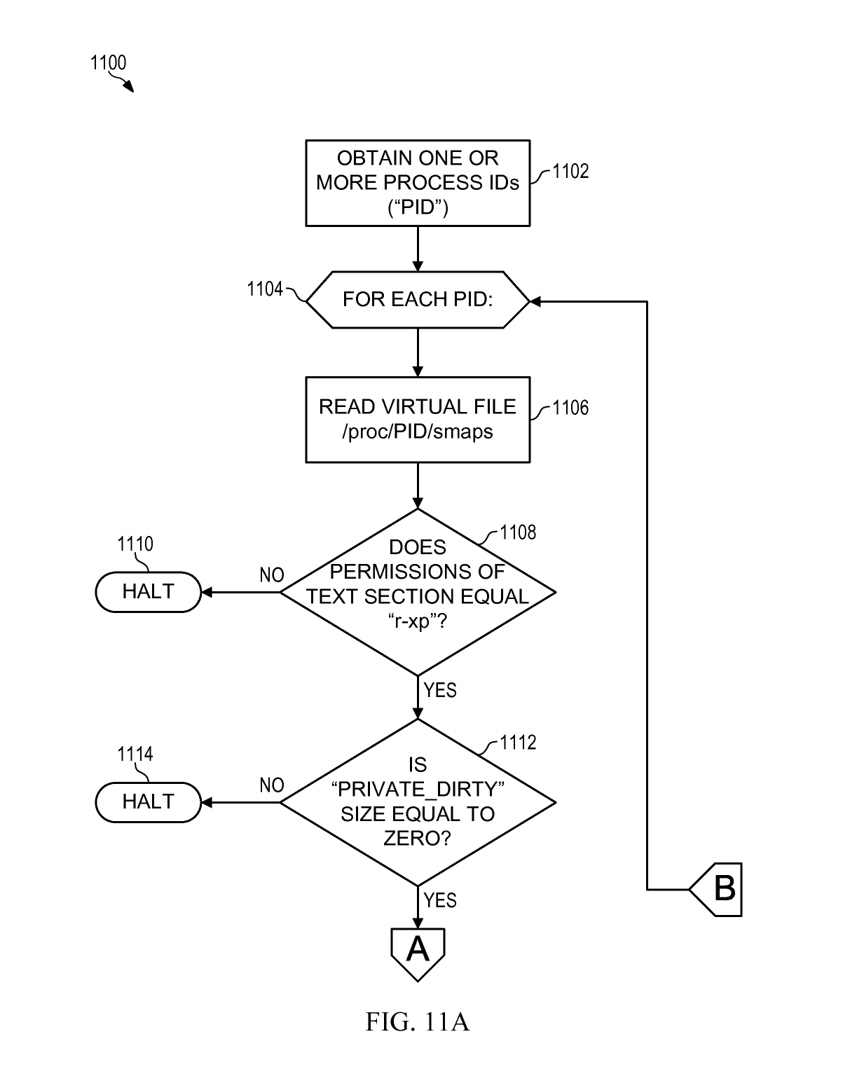

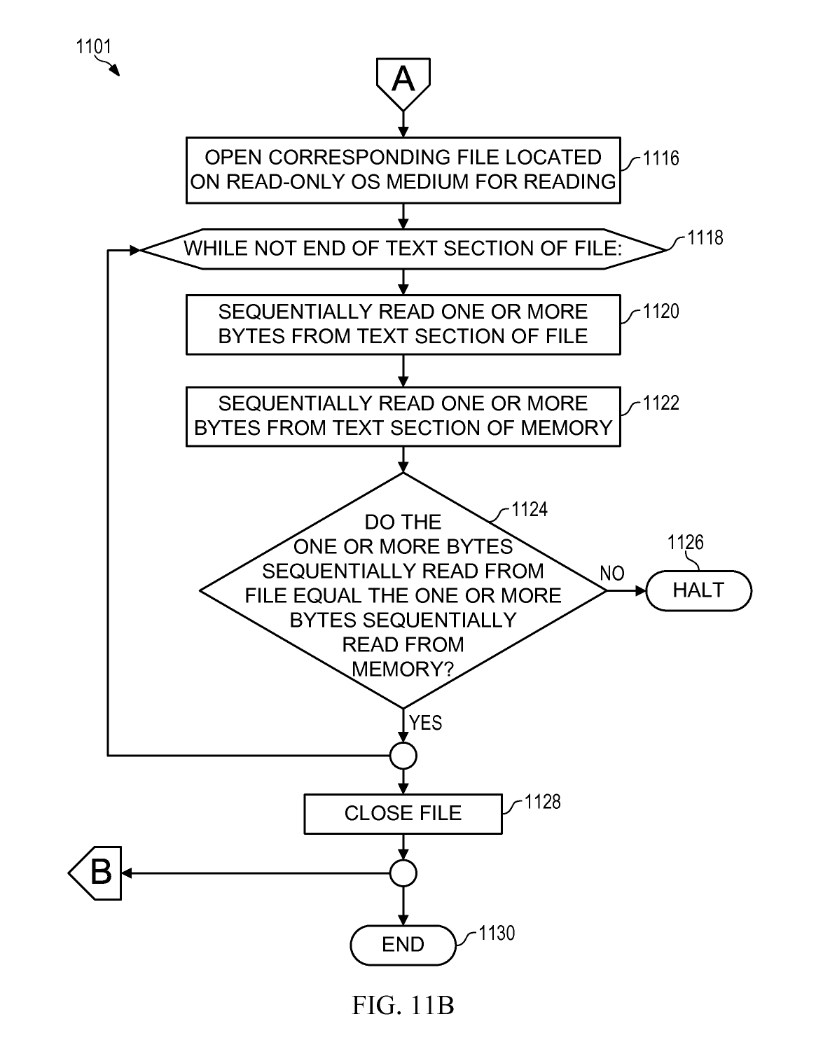

In FIG. 11A, a first part of a validation process flow diagram 1100 is shown, according to one embodiment. The method may include obtaining one or more process IDs (“PID”) (step 1102). The method may include for each PID completing an iterative loop (step 1104). The method may include reading virtual files (e.g., /proc/PID/smaps) (step 1106). The method may include one or more processors determining whether the permission of text section equal (e.g., r-xp) (step 1108). For example, the one or more processors verifies that the Text section is valid. If the permission of text section does not equal, then the method may halt (step 1110). If the permission of text does equal, then the method may include one or more processors determining whether the private-dirty size equals to zero (step 1112). In this example, the one or more processors verifies that the dirty bit is valid. If the private-dirty size does not equal to zero, then the method may halt (step 1114). If the private-dirty size does equal zero, then the method may move to step 1116 (see FIG. 11B).

In FIG. 11B, a second part of the validation process flow diagram 1101 is shown, according to one embodiment. The method may further include opening corresponding file(s) located on read-only OS medium for reading (step 1116). The method may include while not end of text section of file iterative loop (step 1118). The method may include sequentially reading one or more bytes from the text section of the file (step 1120). The method may include sequentially reading one or more bytes from the text section of the memory (step 1122). The method may include one or more processors determining whether one or more bytes sequentially read from file equal the one or more bytes sequentially read from memory (step 1124). If the one or more bytes sequentially read from file does not equal the one or more bytes sequentially read from memory, then the method may halt (step 1126). If the one or more bytes sequentially read from file does equal the one or more bytes sequentially read from memory, then the method may close the file (step 1128). The method may determine whether there is another PID. If there is not another PID, then the method may end (step 1130). If there is another PID, then the method may move to step 1104.

OS medium may be flash memory. For example, OS medium may be a compact flash (“CF”) memory. In another example, OS medium may be a Solid State Drive (“SSD”).

In another embodiment, OS medium may be viewed as a continuous array of sectors. In a further embodiment, an identified partition may include one or more sectors. In one example, OS medium may include at the front end a boot sector. Boot sector may contain code which may allow a CPU to boot the OS medium and load the associated programming. OS medium may then include partition table. Partition table may include instructions for the allocation and/or identification of partitions within OS medium. OS medium may next include an OS partition. OS partition may include instructions related to the loading and/or running of an associated OS. OS medium may also include unused space. In one embodiment, any unused space may be located after the last indexed partition (e.g., OS partition). In another embodiment, any unused space may be located just before a media signature.

Media signature may be located at the end of OS medium. In one embodiment, locating media signature at the end of OS medium may provide an advantage to authenticating OS medium because an associated BIOS and/or BIOS extension may be configured to only look at the end of OS medium for media signature, which in turn may increase associated system security and efficiencies. Media signature may be encrypted. In one embodiment, media signature is encrypted by use of a public-key cryptography system. For example, media signature may be encrypted by use of an Asymmetric Key Encryption (“AKE”) algorithm. One possible AKE algorithm may be the RSA algorithm, but it is contemplated that other AKE algorithms are well-known for public-key cryptography systems, and each such algorithm may be utilized in accordance with various embodiments herein. In one embodiment, a private key may be utilized to encrypt media signature. In another embodiment, a public key (e.g., public key 510 of FIG. 5) may be utilized to decrypt media signature. In one example, once media signature is decrypted, it may be utilized, as discussed more fully below, to authenticate OS medium.

Game assets media may be flash memory. For example, game assets media may be a compact flash (“CF”) memory. In another example, game assets media may be a Solid State Drive (“SSD”).

In another embodiment, game assets media may be viewed as a continuous array of sectors. In a further embodiment, an identified partition may include one or more sectors. In one example, game assets media may include at the front end a boot sector. Boot sector may contain code which may allow a CPU to boot the game assets media and load the associated programming. Game assets media may then include partition table. Partition table may include instructions for the allocation and/or identification of partitions within game assets media. Game assets media may next include a game assets partition. Game assets partition may include instructions related to the loading and/or running of game assets to provide a game. For example, game assets may include paytables and/or game executables. Game assets media may also include unused space. In one embodiment, any unused space may be located after the last indexed partition (e.g., game assets partition). In another embodiment, any unused space may be located just before a media signature.

Media signature may be located at the end of game assets media. In one embodiment, locating media signature at the end of game assets media may provide an advantage to authenticating game assets media because an associated BIOS and/or BIOS extension may be configured to only look at the end of game assets media for media signature, which in turn may increase associated system security and efficiencies. Media signature may be encrypted. In one embodiment, media signature is encrypted by use of a public-key cryptography system. For example, media signature may be encrypted by use of an Asymmetric Key Encryption (“AKE”) algorithm. One possible AKE algorithm may be the RSA algorithm, but it is contemplated that other AKE algorithms are well-known for public-key cryptography systems, and each such algorithm may be utilized in accordance with various embodiments herein. In one embodiment, a private key may be utilized to encrypt media signature. In another embodiment, a public key (e.g., public key 510 of FIG. 5) may be utilized to decrypt media signature. In one example, once media signature is decrypted, it may be utilized, as discussed more fully below, to authenticate game assets media.

In a further embodiment, PKUM may be a flash memory device. For example, PKUM may be a compact flash (“CF”) device. In another example, PKUM may be a Solid State Drive (“SSD”).

In another embodiment, PKUM may be viewed as a continuous array of sectors. In one example, PKUM may include at the front end a boot sector. Boot sector may contain code which may allow a CPU to boot PKUM and load the associated programming. PKUM may then include partition table. Partition table may include instructions for the allocation and/or identification of partitions within game assets media. PKUM may next include a data partition. In one embodiment, data partition may be mostly unused space. In another embodiment, data partition may include a public key. For example, a public key associated with a gaming system (e.g., public key 510 of FIG. 5) may require replacement, and data partition may include such replacement public key.

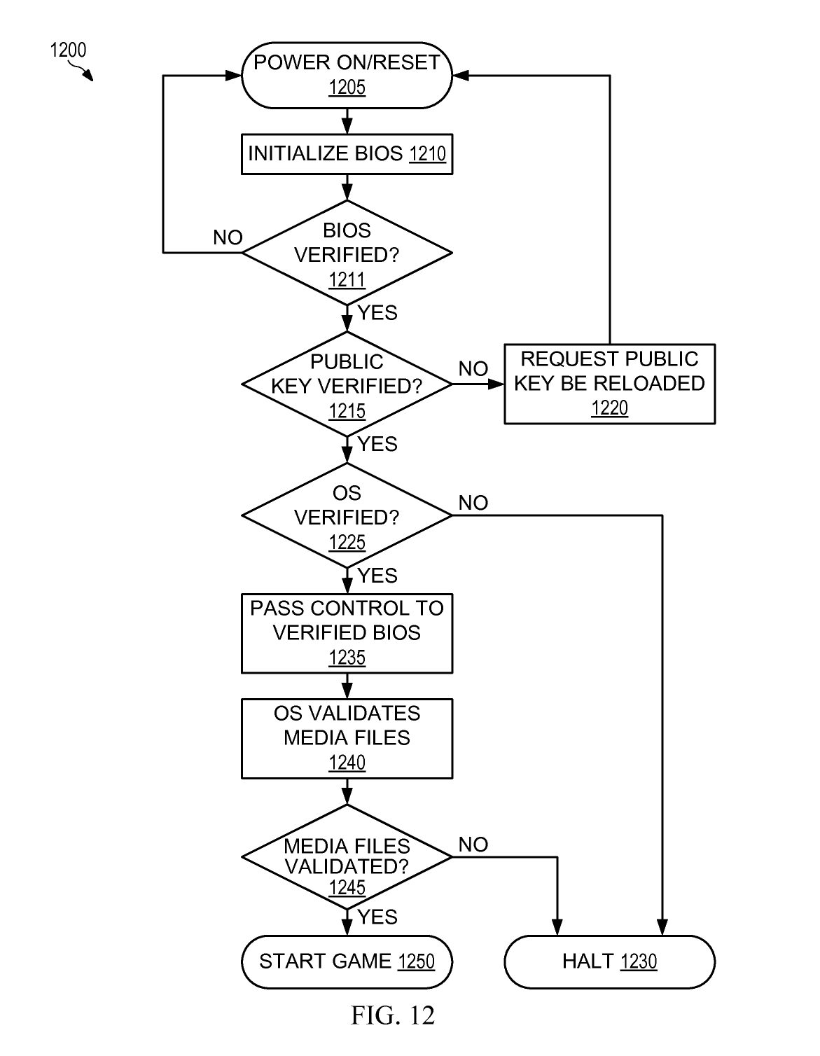

FIG. 12 is a flow diagram for ROM-based media validation, according to one embodiment. Specifically, FIG. 12 generally illustrates a shared authentication process 1200. In one embodiment, shared authentication process 1200 begins with a power on and/or reset action, which may cause a gaming system to boot up (step 1205).

In one embodiment, a next step may be to initialize the BIOS (step 1210). In one embodiment, initializing the BIOS causes error-detecting code to be run on data contained on an association ROM, which may determine that there are no errors and the boot process may continue. For example, a cyclic redundancy check (“CRC”) may be initiated and run for an associated ROM. In another embodiment, initializing the BIOS may also check associated BIOS extensions for any errors. In a further embodiment, initializing the BIOS may also initialize and/or configure hardware associated with the gaming system.

At step 1215, an associated public key is verified. In one embodiment, an associated BIOS causes the public key to be verified. In another embodiment, an associated BIOS extension causes the public key to be verified. In a further embodiment, the public key is checked to see if it has been corrupted. For example, if it was determined that an encrypted media signature of an associated OS medium could not be properly decrypted with the provided public key, step 1215 may fail.

If an associated public key is not verified at step 1215, a request for the public key to be reloaded is generated at step 1220. In one embodiment, such a request may be caused to be displayed on an associated display device. In another embodiment, such a public key that is similar and/or the same as a prior public key may be reloaded. In a further embodiment, a different public key may be loaded. In one embodiment, the reloading of a public key is done via PKUM. For example, if a public key was not verified at step 1215, a request for a reloading of a public key may be generated at step 1220, which may cause an operator to insert into, and/or otherwise place in communication with, a gaming system and/or PKUM which may contain a new and/or otherwise uncorrupted public key. Once a public key has been reloaded at step 1220, shared authentication process 1200 may return to step 1205 and reboot.

If the public key is verified at step 1215, shared authentication process 1200 may then attempt to verify the OS at step 1225. In one embodiment, the BIOS causes the check of the OS at step 1225. In another embodiment, a BIOS extension causes the check of the OS at step 1225. In one embodiment, and as discussed more fully below, a gaming system may utilize a verified public key and a media signature of an associated OS medium to verify the OS at step 1225. If the OS cannot be verified at step 1225, shared authentication process 1200 may proceed to step 1230 where it may halt and prevent the gaming system from further booting and/or starting. In one embodiment (not shown), if the OS is validated at step 1225, the OS is then loaded. For example, the BIOS may proceed to load the OS. In another example, a BIOS extension may pass control back to the BIOS to load the OS.

If the OS is validated at step 1225, control may be passed to the verified OS at step 1235. In one embodiment, control may be passed from the BIOS. In another embodiment, control may be passed from a BIOS extension. In one embodiment, the OS is configured to validate associated media files at step 1240. It is contemplated that passing control to a verified OS to validate associated media files may maintain security while also expediting the remainder of the verification process. For example, the OS may be configured to utilize Direct Memory Access (“DMA”) and/or read-ahead buffering techniques, which may allow it to check associated media files much faster than the BIOS and/or a BIOS extension, could check the associated media files. It is contemplated that such shared authentication may provide significant benefits, by expediting the boot and/or authentication process, and/or by freeing up the BIOS to perform other tasks.

At step 1245, it is determined whether the media files have been validated. In one embodiment, the media files are validated in a similar manner that the OS was verified at step 1225, and discussed more fully below. For example, a same and/or similar public key that was utilized to verify the OS may be used to verify the media files. In another embodiment, the media files are validated through use of a different methodology.

If one or more media files are not validated at step 1245, shared authentication process 1200 may proceed to step 1230 where it may halt and prevent the gaming system from starting. If the media files are validated at step 1245, shared authentication process 1200 may proceed to step 1250, where the game is allowed start.

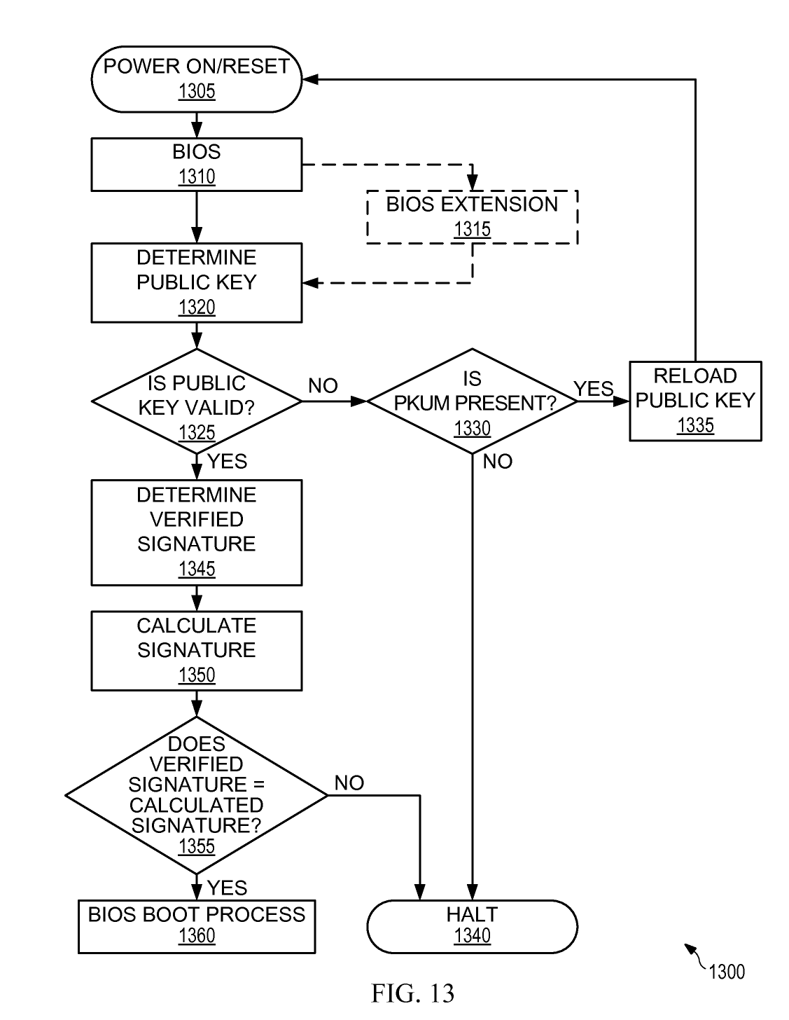

FIG. 13 is another flow diagram for ROM-based media validation, according to one embodiment. Specifically, FIG. 13 generally illustrates an OS authentication process 1300. In one embodiment, OS authentication process 1300 begins with a power on and/or reset action 1305, which may cause a gaming system to boot up.

In one embodiment, a next step may be to initialize the BIOS (step 1310). In one embodiment, initializing the BIOS causes error-detecting code to be run on data contained on an association ROM, which may determine that there are no errors and the boot process may continue. For example, a cyclic redundancy check (“CRC”) may be initiated and run for an associated ROM. In a further embodiment, initializing the BIOS may also initialize and/or configure hardware associated with the gaming system.

In another embodiment, initializing the BIOS may also check associated BIOS extensions for any errors and may then pass control to the BIOS extension at step 1315. In this example, step 1315 is shown in dashed form to illustrate that this may be the process for certain embodiments. It is contemplated that it may be particularly beneficial to pass control of certain authentication procedures to a BIOS extension, as then the procedures may be customized for a particular application without having to reconfigure the BIOS code, which may be time consuming and/or cause unintended consequences.

In one embodiment, it is contemplated that there may be particular advantages to utilizing a BIOS extension and/or implementing a sector-by-sector authentication procedures. For example, a manifest file and/or file-system logic may not need to reside within the BIOS and/or an associated BIOS extension. In another example, a gaming manufacturer may be able to utilize the same BIOS for all jurisdictions, and they may only need to add a BIOS extension for those jurisdictions that require authentication. In a further example, by utilizing a BIOS extension, the BIOS file size can be maintained, which may help with hardware limitations.

The next step in the OS authentication process 1300 may be to determine the public key at step 1320. In one embodiment, this may be done by accessing the public key from an associated memory device. For example, an associated SRAM may store the public key.

At step 1325, it may be determined if the public key is valid. In one embodiment, the public key is checked to see if it has been corrupted. For example, if it was determined that an encrypted media signature of an associated OS medium could not be properly decrypted with the provided public key, step 1325 may fail.

If the public key is determined not valid and/or otherwise corrupted at step 1325, OS authentication process 1300 may then determine if PKUM is present at step 1330. In one embodiment (not shown), the system may cause an associated display device to display a message to load and/or otherwise place in communication with the gaming system PKUM. If the system determines that no PKUM is present at step 1330, OS authentication process 1300 may proceed to step 1340 and halt further operations, which may prevent the gaming system from allowing game play.

Once PKUM has been placed in communication with the gaming system, and/or once it has been determined that PKUM is present, OS authentication process may continue to step 1335 and reloads the public key. In one embodiment, the reloaded public key may be a new public key. In another embodiment, the reloaded public key may be an identical copy of a previous public key that existed on the gaming system. In a further embodiment, a reloaded public key may amend part of the previously loaded public key. Once a public key has been reloaded at step 1335, OS authentication process 1300 may return to the beginning step at 1305 and reboot.

If at step 1325, the public key is determined to be valid, OS authentication process 1300 may proceed to step 1345 and determine a verified signature. In one embodiment, the validated public key may be utilized to decrypt a media signature from an associated OS medium. In another embodiment, the BIOS and/or BIOS extension may determine the size of the OS Medium, and may then load the sector configured to store the media signature (e.g., the last sector). In one embodiment, the decrypted media signature may include a verified medium signature.

At step 1350, which may occur before, simultaneously with, and/or after step 1345, a signature is calculated. In one embodiment, the validated public key may be utilized to decrypt a media signature from an associated OS medium. In another embodiment, the decrypted media signature may include a verification range. For example, the decrypted media signature may include at least one sector beginning point and at least one sector ending point of the associated OS medium that, when hashed with an appropriate cryptographic hashing function (e.g., a Secure Hashing Algorithm (“SHA”)) will generate a unique signature. In another embodiment, the decrypted media signature may also include the cryptographic hashing function to apply to the verification range. In another embodiment, the cryptographic hashing function may be pre-loaded and/or otherwise standardized for use on the gaming system. In one embodiment, the BIOS and/or a BIOS extension then may utilize the appropriate cryptographic hashing function to create a hash from the identified verification sector range and/or ranges, which may generate a calculated signature. In one embodiment, it may be particularly beneficial to locate a media signature (e.g., media signature) distinct from other sectors (e.g., OS partition). For example, this may allow the OS medium to run on a gaming system that is not configured to validate the OS medium. In another example, a gaming manufacturer may be able to utilize identical OS mediums in jurisdictions that require and/or do not require authentication of the OS medium. In one such example, the gaming manufacturer may only need to include BIOS and/or a BIOS extension that is configured to validate the OS medium for those jurisdictions that require such actions. It is readily apparent that this may be beneficial for operational flexibility.

At step 1355, the verified signature from step 1345 is compared to the calculated signature from step 1350 to determine if they match. It should be apparent that the verified signature is generated from the OS medium as the OS medium is intended to be distributed by the gaming system manufacturer, and that a different and/or altered OS medium inserted into a gaming system may cause a different signature to be generated as the different and/or altered OS medium which will not have the identical partitions and/or sectors of code stored at the identical range(s) of the medium. In this manner, it is contemplated that such a verification check may prevent unauthorized OS implementations.

If the signatures do not match at step 1355, then OS authentication process 1300 may proceed to step 1340, and halt the gaming system from running and/or halting game play. If the signatures do match at step 1355, then OS authentication process 1300 may proceed to step 1360 and allow the BIOS to continue with the boot process. In one embodiment, the BIOS may pass control of part or all of the remaining boot process to another process. For example, BIOS may pass off control to a BIOS extension. In another example, BIOS may pass control to the verified OS, which may then proceed with part or all of the remaining boot process.

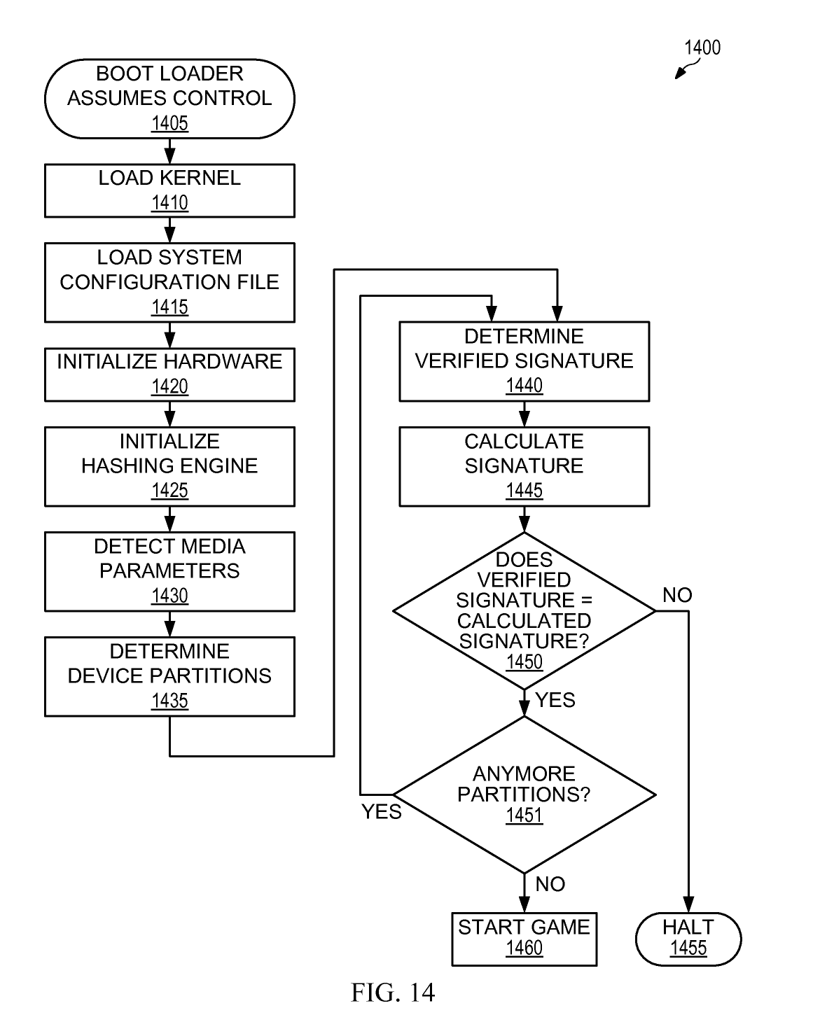

FIG. 14 is another flow diagram for ROM-based media validation, according to one embodiment. Specifically, FIG. 14 generally illustrates a media authentication process 1400. In one embodiment, media authentication process 1400 may be utilized to validate an associated OS medium. In another embodiment, media authentication process 1400 may be utilized to validate game and assets media. In a further embodiment, media authentication process may be utilized to validate other media associated with a gaming system.

In one embodiment, media authentication process 1400 may begin at step 1405 when a boot loader assumes control of the validation process. In one embodiment, the BIOS may pass control to the boot loader. In another embodiment, control may be passed to the boot loader after the OS has been authenticated. In a further embodiment, the boot loader may comprise part of the BIOS. In still another embodiment, the boot loader may comprise part of a BIOS extension. In a further embodiment, the boot loader may be stored on a separate memory device from the BIOS and/or BIOS extension. In one embodiment, the boot loader may load other data and/or programs which may then be executed from RAM.

At step 1410, the boot loader may load the kernel from an associated boot partition. In one embodiment, the boot loader will then jump to the kernel entry point. In another embodiment, the loaded kernel may manage the communication between various software and hardware components. In a further embodiment, the loaded kernel may assume control of the remaining boot process. In another embodiment, the loaded kernel may assume control of the remaining validation processes.

At step 1415, the kernel may initialize one or more hardware components. In one embodiment, the kernel may then load a system configuration file at step 1420. It is contemplated that part of the system configuration file may include one or more scripts which are configured to validate one or more media. In one embodiment, the one or more scripts which are configured to validate one or more media are configured to be the last scripts to be executed by the system configuration file. In another embodiment, the one or more scripts which are configured to validate one or more media are configured to be the first script to be executed by the system configuration file. In a further embodiment, the one or more scripts which are configured to validate one or more media are configured to be one of the last scripts to be executed by the system configuration file.

In one embodiment, steps 1425 through 1450 may be part of one or more scripts which are configured to validate one or more media. At step 1425, a hashing engine may be initialized. In one embodiment, such initialized hashing engine may control one or more of the following steps of FIG. 14.

At step 1430, media authentication process 1400 may proceed to detect one or more parameters for one or more associated media. In one embodiment, the initialized hashing engine controls such detection. In another embodiment, media authentication process 1400 may cause parameters to be detected for all present media. In another embodiment, media authentication process 1400 may cause parameters to be detected for media other than the OS medium. For example, it may be that the OS medium has already been verified before media authentication process 1400 is implemented, therefor there would not be a need to repeat such authentication.

At step 1435, media authentication process 1400 may proceed to determine partition locations of one or more associated media devices. In one embodiment, the determination of partition locations may also determine the locations of one or more associated sectors. In a further embodiment, the initialized hashing engine controls such detection. In another embodiment, media authentication process 1400 may cause partition locations to be determined for all present media. In another embodiment, media authentication process 1400 may cause partition locations to be determined for media other than the OS medium. For example, it may be that the OS medium has already been verified before media authentication process 1400 is implemented, therefor there would not be a need to repeat such authentication.

At step 1440, media authentication process 1400 may determine the verified signatures for one or more associated media. In one embodiment, the initialized hashing engine may control such determination. In another embodiment, a public key may be utilized to decrypt a media signature. In one example, the decrypted media signature may include a verified signature for that media.

At step 1445, media authentication process 1400 may proceed to calculate a signature. It is contemplated that step 1445 can occur before, after, and/or simultaneous with step 1440. In another embodiment, a public key may be utilized to decrypt a media signature. In one example, the decrypted media signature may include at least one beginning sector point and at least one sector ending point which may be utilized to reproduce part and/or all of the verified signature. In a further example, the decrypted media signature may include a cryptographic hashing function, (e.g., a SHA). In a further example, the decrypted media signature may include an identification of a cryptographic hashing function, (e.g., a SHA) that should be utilized, and which may need to be loaded from elsewhere within the gaming system. In another example, utilizing a cryptographic hashing function from the decrypted media signature to hash the sector and/or sectors of the associated media delineated by the identified at least one beginning and/or ending sector points may reproduce an exact replica of the verified signature.

At step 1450, the verified signature from step 1440 is compared to the calculated signature from step 1445 to determine if they match. It should be apparent that the verified signature is generated from the media as the media is intended to be distributed by the gaming system manufacturer, and that a different and/or altered media inserted into a gaming system may cause a different signature to be generated as the different and/or altered media which will not have the identical partitions and/or sectors of code stored at the identical range(s) of the media. In this manner, it is contemplated that such a verification check may prevent unauthorized media implementations.

If the signatures do not match at step 1450, then media authentication process 1400 may proceed to step 1455, and halt the gaming system from running and/or halting game play. If the signatures do match at step 1450, then media authentication process 1400 may proceed to step 1460 and allow the game to start.

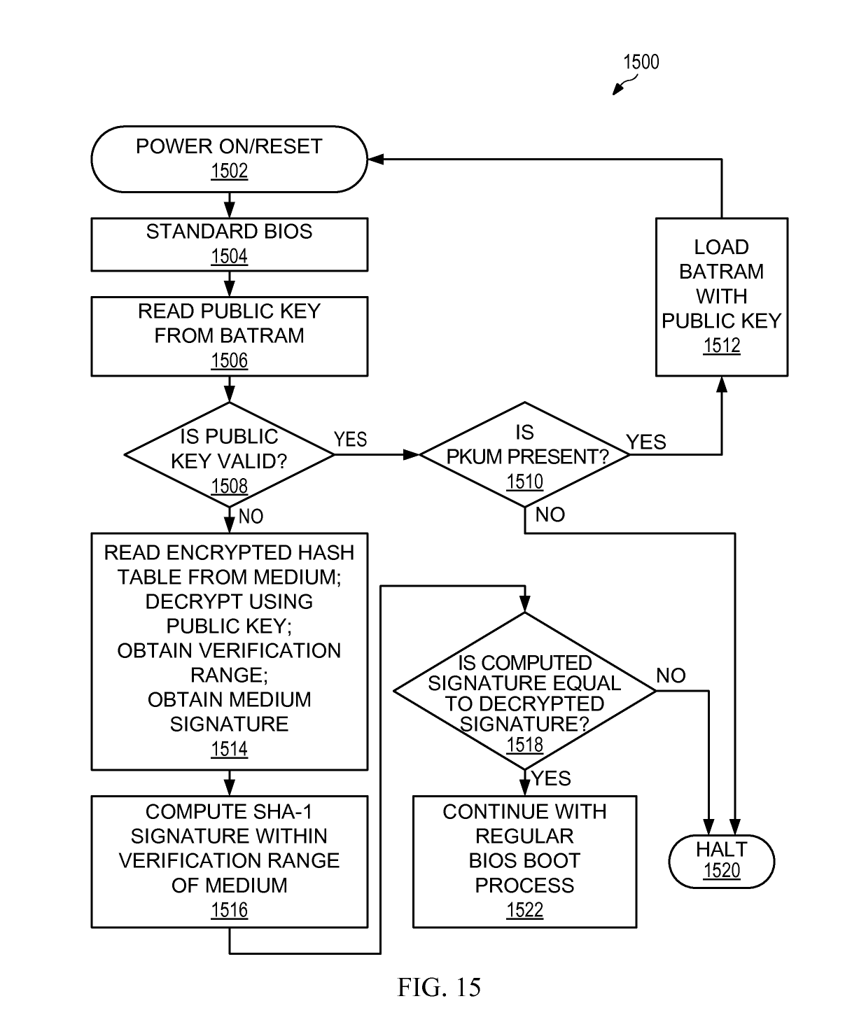

In FIG. 15, a flow diagram for ROM-based media validation is shown, according to one embodiment. The method may include a powering on and/or a reset step (step 1502). The method may include implementing a standard BIOS (step 1504). The method may include reading a public key from BATRAM (step 1506). The method may include determining whether the public key is valid (step 1508). If the public key is invalid, then the method may determine whether the PKUM is present (step 1510). If the PKUM is not present, then the method may halt (step 1520). If the PKUM is present, then the method may include loading the BATRAM with the public key (step 1512) and then the method moves back to step 1502. If the public key is valid, then the method may include reading encrypted hash table from medium, decrypting using the public key, obtaining verification range, and/or obtaining medium signatures (step 1514). The method may include computing SHA-1 signature (or other similar signature(s)) within the verification range of medium (step 1516). The method may include determining whether the computed signature is equal to the decrypted signature (step 1518). If the computed signature is not equal to the decrypted signature, then the method may halt (step 1520). If the computed signature is equal to the decrypted signature, then the method may continue with regular BIOS boot process (step 1522). The method may include one or more signatures and/or any other elements.

In one example, a method of implementing the required software chain-of-trust using a motherboard. In one example, the systems, devices, and/or methods of this disclosure may be utilized in jurisdictions that have the requirements that a verifiable link from the authentication system to a conventional ROM device. In these jurisdictions there should be an unbroken chain of trust beginning from the BIOS chips all the way to the game executable. In one example, a devise may utilize a custom BIOS that can perform media authentication before even the OS is loaded. In one example, the authentication algorithm utilized may be compatible with these limitations of the motherboard currently in use (e.g., the iBase CJ-2009B). In one example, the CJ-2009B motherboard only provides enough address lines for a 2 MB ROM to the ROM socket. This limitation may prevent the use of the Linux kernel being placed in the ROM chip, as well as having any sort of complex file-system-based authentication. However, other systems may be utilized to overcome this limitation.

In one example, the ROM address space limitation may be more limiting because the BIOS itself already uses 1 MB or half of the total space available. That means the authentication algorithm must be small and efficient. In one example, it would not be possible to fit a file-by-file verification algorithm because that would require file-system logic in the BIOS, which requires fitting an OS with initialization routines and a kernel in just under 1 MB.

In one example, the system and/or method may be sector I/O based. In one example, by using the sector I/O routines already available in the BIOS, a BIOS extension may be utilized. This BIOS extension may read each used sector of the boot-able OS medium and produce a calculated signature. This signature may then be compared with a known good signature (e.g., reference signature). If the signatures match, then control may be passed back to the BIOS, and it proceeds to load the boot sector from disk. If the signatures do not match, then the method may halt execution and notifies the user that the medium is invalid. In one example, if the one or more signatures are stored in the BIOS ROM chip, then it would be necessary to replace it for each software media update, which is undesirable and costly. In another example, if the raw one or more signatures are stored in the medium itself however, then it would become a threat that one or more potential perpetrators finds the one or more signatures and change the medium. However, since storing the one or more signatures in the medium itself gives us the most operational flexibility, we must find a way to obscure the signature. In one example, an Asymmetric Key Encryption (“AKE”) algorithm can be used to achieve this. For the security purposes, when generating a media set, each signature would be encrypted using a Private Key. Since the Private Key is only known to a few authorized individuals in the company, security is increased.

When the Private Key is generated, a Public Key is also produced. The Public Key is related to the Private Key in such a way that the medium signature can be decrypted using the Public Key, but the Private Key is needed for encryption. The Public Key can be widely known, without affecting security.

In one example, once the medium signature is encrypted, the method will need to access the Public Key in order to decrypt it. The Public Key could be stored in ROM, but if the Private Key ever gets compromised, the BIOS and the media in all EPS's in the field would have to be replaced, which is a very costly operation. In another example, the storing of the Public Key in a media that can be updated provides various benefits. The Battery-Backed PCI SRAM (BATRAM) found in the CJ-2009B motherboard is a medium that can be utilized for this purpose. In one example, if the Private Key ever gets compromised, only the media in the EPS's need be replaced. The BIOS extension will detect that the signature could not be decrypted correctly and will ask the operator to insert a Public Key Update Medium (“PKUM”) in the correct slot and reboot the EPS. Upon reboot, the BIOS extension will detect the PKUM and proceed to update the BATRAM and reboot again. In another example, another aspect that must be kept in mind: the amount of time it takes to validate the entire media set using the BIOS sector logic alone can be excessive. It is better to just check the used space in the OS medium first, and then pass control to the already-validated OS.

In one example, once initialized, the OS can start a Media Validation (“MeV”) program. The MeV's function is to validate the remaining media using the OS's sector access logic, which uses DMA and read-ahead buffering techniques. This enables the medium checking to be performed much faster than the BIOS Programmed-I/O (“PIO”) method. In one example, to avoid checking the entire medium contents, the BIOS extension can be given the starting and ending sector range. This information may also need to be encrypted for security purposes. It can be stored in a “C” language structure together with the medium signature. The whole structure may then be encrypted and stored in the last sector of the medium.

In various examples, .TEXT, .DATA, .BSS, .RODATA, and/or any other language structure may be utilized with any of the systems, devices, and/or method in this disclosure. In various examples, software, firmware, memory storage elements, and/or another other device may be utilized. In various examples, one or more cards may be utilized.

In one example, storing the public key in BATRAM allow for significant flexibility in security management. If the private key ever gets compromised, a BIOS update will not be necessary to change the public key installed in each EPS. In another example, by using the existing BIOS sector I/O logic through a BIOS extension, the system, device and/or method can implement the security requirements for one or more jurisdictions within the limitations of the CJ-2009B motherboard. In another example, the OS media can run with or without the Secure BIOS, thus maximizing operational flexibility. In another example, media verification is performed in a sector I/O basis, thus no manifest file or file-system logic is required to reside in the BIOS.

In another example, the system ROM may be the home for the BIOS and the BIOS extension. The BATRAM may be used to store not only the public key, but also persistent game data, according to one embodiment. In one example, the PKUM is usually not connected to the EPS, except in case of public key corruption. In one example, the game and assets media might be split between one or more media. In another example, the OS Medium may be contained in a single device.

In one example, the media used with the EPS's are all of the Flash memory type, which will be either a CompactFlash (CF) card and/or a Solid State Drive (SSD). In one example, these media can be viewed as a continuous array of sectors. In one example, the internal controller on each device may make sure that any bad sectors in the flash memory array are replaced by a known-good sector from an over-provision pool of good sectors.

In one example, the Media Signature structure is located in the last sector of the medium. Here is it's “C” representation:

| typedef struct MEDIA_BLK | |
|---|---|
| { | |
| uint8_t | Message_Digest[ SHA1_HASH_SIZE ]; |
| uint32_t | StartLoc; |
| uint32_t | StopLoc; |

} MEDIA_BLK_t;

In this example, there is no boot partition. In one example, the Boot sector and the partition table remain in their positions for correct media configuration. In one example, the Game Executables are on different media, but the basic layout will remain the same. In another example, in the PKUM, there will be only one partition. It will have only one file, which will contain the Public Key. This file is read by the BIOS extension and placed in the BATRAM. In one example, this only occurs when the BIOS extension finds that the Public Key has been corrupted

In one example, the BIOS initializes as usual, performing a CRC-16 check of the entire ROM contents before executing (that includes the BIOS extension. After the BIOS has initialized and configured the hardware, it passes control to the BIOS extension. In one example, the BIOS then reads the Public key from BATRAM. If the Public Key is not corrupted, it proceeds to check the OS medium. If the Public Key is corrupted, then BIOS extension will attempt to load the Public Key from the PKUM. If it is not present, BIOS extension may display a message on the screen requesting the operator to insert the PKUM device in the correct slot and reboot. In this case BIOS extension may halt further execution and the operator may have to recycle power.

Upon determination that the Public Key is valid, the BIOS extension proceeds to check the OS Medium. BIOS extension may determine the size of the OS Medium and then load the load the last sector. This contains the MEDIA_BLK structure discussed above. From this structure BIOS extension may find the range of sectors to check and the known-good signature of the medium.

In one example, BIOS extension may then perform a SHA-1 signature of all sectors within the designated range and then compare the calculated signature with the one stored in the MEDIA_BLK structure. If the signatures are identical, then BIOS extension returns control to the BIOS and the boot process continues as normal: the boot sector is loaded; control is passed to the Boot-Loader, which then loads the kernel and executes it.

In one example, if the signatures do not match, the BIOS extension will present a message to the operator reporting the error and then halt execution, to prevent the loading of malicious software. After the BIOS is done with the validation of OS CF, it will try to load the boot-loader. The BIOS then passes control to the boot-loader, which loads the kernel from the boot partition. The boot-loader will then jump to the kernel entry point. The kernel will initialize the hardware and then load the initial program, which starts the system configuration. MeV will be invoked at the end of the system configuration phase. A script named “MeV.start” will be placed under /etc/local.d for this purpose.

In one example, MeV will initialize the hashing engine and then try to detect the parameters for all present media. Next, MeV will search which device contains which partitions. MeV will ignore the root and boot partitions, since they have been checked by the BIOS previously. The MeV validation process will be very similar to what the BIOS does, only much faster. MeV will check the Player CF first, and then the Assets CF. The game shall not be started before the completion of the validation process. MeV will open the device file for the corresponding media (e.g. /dev/sdb) and then MeV will read the start and stop sector numbers as given in the MEDIA_BLK_t structure above, located in the next to last sector. It will then start reading blocks of sectors from the StartLoc sector up to StopLoc sector into memory. MeV will calculate the SHA-1 of that block, load the next block and continue until done with the partition verification. If the Player CF partition verifies correctly, MeV will proceed to check the Assets CF. If any partition fails verification, MeV will display a message on the screen warning the operator if a mismatch has been found, and then hang the system. This will prevent the system from being started with any malicious software.

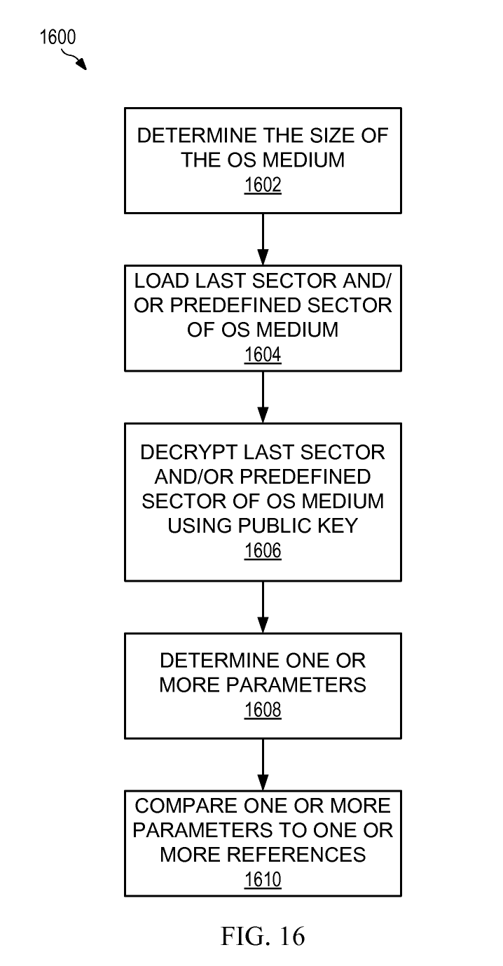

In FIG. 16, a flow diagram for ROM-based media validation is shown, according to one embodiment. The method may include determining the size of the OS medium (step 1602). The method may include loading the last sector and/or one or more predefined sectors of the OS medium (step 1604). The method may include decrypting the last sector and/or one or more predefined sectors of the OS medium using the public key (step 1606). The method may include determining one or more parameters (step 1608). The method may include comparing the one or more parameters to one or more references (step 1610).

In an exemplary embodiment, the electronic gaming system may include one or more read-only memory devices. The one or more read-only memory devices may store a plurality of instructions. The electronic gaming system may include one or more read/write memory devices. The one or more read/write memory devices may store a first public key. The electronic gaming system may include an operating system medium. The operating system medium may store one or more of an operating system and one or more encrypted operating system medium signatures. The electronic gaming system may include one or more game assets media. The one or more game assets media may store one or more game asset files. The electronic gaming system may include a wager acceptor. The electronic gaming system may include one or more processors, which may receive the plurality of instructions, which when executed by the one or more processors, cause the one or more processors to operate with the one or more read/write memory devices, the operating system media, the one or more game assets media, and/or the wager acceptor to determine if the first public key is able to decrypt the encrypted operating system medium signature. If the first public key is not able to decrypt the encrypted operating system medium signature, the system and/or method may cause a display device to display a request to update the first public key and return to decrypt the encrypted operating system medium signature, determine a verified hash signature from the decrypted operating system medium signature, determine a verification range from the decrypted operating system medium signature, calculate a hash signature based on the verification range, and/or determine if the verified hash signature matches the calculated hash signature. If the verified hash signature does not match the calculated hash signature, the system and/or method may prevent the wager acceptor from accepting a wager. If the verified hash signature does match the calculated hash signature, the system and/or method may cause the one or more processors to receive a plurality of instructions from the operating system, which when executed by the one or more processors, cause the one or more processors to operate with the one or more read/write memory devices, the one or more operating system media, the one or more game assets media, and the wager acceptor to verify that the one or more game assets media is authentic. If the one or more game assets media is determined to not be authentic, the system and/or method may prevent the one or more game asset files from loading. If the one or more game assets media is determined to be authentic, thereafter allow the wager acceptor to accept a wager.

In another example, the one or more game assets media may further stores one or more encrypted game assets media signatures and the instructions received from the operating system cause the one or more processors to operate with the one or more read/write memory devices, the one or more operating system media, the one or more game assets media, and the wager acceptor to decrypt the one or more encrypted game assets media signatures, determine a verified game assets hash signature from the one or more decrypted game assets media signatures, determine a game assets verification range from the one or more decrypted game assets media signatures, calculate a game assets hash signature based on the game assets verification range, and/or determine if the game assets verified hash signature matches the game assets calculated hash signature. If the verified game assets hash signature does not match the calculated game assets hash signature, determine that the game assets media is not authentic. If the verified game assets hash signature does match the calculated game assets hash signature, determine that the game assets media is authentic.

In another example, the first public key decrypts the encrypted game assets media signature. In another example, at least a part of the plurality of instructions are from a BIOS extension stored on the at least one read-only memory device. In another example, at least a part of the plurality of instructions are from a BIOS stored on the at least one read-only memory device. In another example, the one or more processors may receive instructions from a public key update medium which when executed by the at least one processor, cause the one or more processors to update the first public key. In another example, the updating of the first public key comprises replacing the first public key with a second public key. In another example, the calculating of the hash signature based on the verification range may include determining a first sector and a second sector from the verification range, locating the first sector on the operating system medium, locating the second sector on the operating system medium, determining a block of sectors from the first sector to the second sector, and/or applying a cryptographic hashing function to the determined block of sectors.

In one embodiment, the electronic gaming system may include at least one read-only memory device where the at least one read-only memory device stores a BIOS and a BIOS extension, at least one read/write memory device, where the at least one read/write memory device stores a first public key, an operating system medium, where the operating system medium may store one or more of an operating system. The electronic gaming system may include an encrypted operating system medium signature, at least one processor which may receive a first plurality of instructions from the BIOS, which when executed by the at least one processor, cause the at least one processor to operate with the at least one read/write memory device, the operating system media, and the wager acceptor to begin a gaming system boot process, receive a plurality of instructions from the BIOS extension, which when executed by the at least one processor, cause the at least one processor to operate with the at least one read/write memory device, the operating system media, and the wager acceptor to determine if the first public key is able to decrypt the encrypted operating system medium signature. If the first public key is not able to decrypt the encrypted operating system medium signature, the system and/or method may cause a display device to display a request to update the first public key and return to decrypt the encrypted operating system medium signature, determine a verified hash signature from the decrypted operating system medium signature, determine a verification range from the decrypted operating system medium signature, calculate a hash signature based on the verification range, determine if the verified hash signature matches the calculated hash signature. If the verified hash signature does not match the calculated hash signature, the system and/or method may prevent the gaming system boot process from completing. If the verified hash signature does match the calculated hash signature, the system and/or method may cause the at least one processor to receive a second plurality of instructions from the BIOS and complete the gaming system boot process based on the second plurality of instructions from the BIOS.

In another example, the at least one processor may receive instructions from a public key update medium which when executed by the at least one processor, cause the at least one processor to update the first public key. In another example, the updating of the first public key comprises replacing the first public key with a second public key. In another example, the calculating of the hash signature based on the verification range may include determining a first sector and a second sector from the verification range, locating the first sector on the operating system medium, locating the second sector on the operating system medium, determining a block of sectors from the first sector to the second sector, and/or applying a cryptographic hashing function to the determined block of sectors. In another example, the electronic gaming system may include at least one game assets media, where the at least one game assets media stores at least one game asset file and an encrypted game asset media signature.

In another example, the at least one processor may receive a plurality of instructions from the operating system, which when executed by the at least one processor, cause the at least one processor to operate with the at least one read/write memory device, the operating system media, and the at least one game assets media to decrypt the encrypted game assets media signature, determine a verified game assets hash signature from the decrypted game assets media signature, determine a game assets verification range from the decrypted game assets media signature, calculate a game assets hash signature based on the game assets verification range, and/or determine if the game assets verified hash signature matches the game assets calculated hash signature. If the verified game assets hash signature does not match the calculated game assets hash signature, the system and/or method may determine that the game assets media is not authentic. If the verified game assets hash signature does match the calculated game assets hash signature, the system and/or method may determine that the game assets media is authentic.

Gaming system may be a “state-based” system. A state-based system stores and maintains the system's current state in a non-volatile memory. Therefore, if a power failure or other malfunction occurs, the gaming system will return to the gaming system's state before the power failure or other malfunction occurred when the gaming system may be powered up.

State-based gaming systems may have various functions (e.g., wagering, payline selections, reel selections, game play, bonus game play, evaluation of game play, game play result, steps of graphical representations, etc.) of the game. Each function may define a state. Further, the gaming system may store game histories, which may be utilized to reconstruct previous game plays.

A state-based system may be different than a Personal Computer (“PC”) because a PC is not a state-based machine. A state-based system has different software and hardware design requirements as compared to a PC system.

The gaming system may include random number generators, authentication procedures, authentication keys, and operating system kernels. These devices, modules, software, and/or procedures may allow a gaming authority to track, verify, supervise, and manage the gaming system's codes and data.

A gaming system may include state-based software architecture, state-based supporting hardware, watchdog timers, voltage monitoring systems, trust memory, gaming system designed communication interfaces, and security monitoring.

For regulatory purposes, the gaming system may be designed to prevent the gaming system's owner from misusing (e.g., cheating) via the gaming system. The gaming system may be designed to be static and monolithic.

In one example, the instructions coded in the gaming system are non-changeable (e.g., static) and are approved by a gaming authority and installation of the codes are supervised by the gaming authority. Any change in the system may require approval from the gaming authority. Further, a gaming system may have a procedure/device to validate the code and prevent the code from being utilized if the code is invalid. The hardware and software configurations are designed to comply with the gaming authorities' requirements.

As used herein, the term “mobile device” refers to a device that may from time to time have a position that changes. Such changes in position may comprise of changes to direction, distance, and/or orientation. In particular examples, a mobile device may comprise of a cellular telephone, wireless communication device, user equipment, laptop computer, other personal communication system (“PCS”) device, personal digital assistant (“PDA”), personal audio device (“PAD”), portable navigational device, or other portable communication device. A mobile device may also comprise of a processor or computing platform adapted to perform functions controlled by machine-readable instructions.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” and/or “another example” should be considered to mean that the particular features, structures, or characteristics may be combined in one or more examples.

1. An electronic gaming system comprising:
at least one read-only memory device, wherein the at least one read-only memory device stores a plurality of instructions;
at least one random-access device, wherein the at least one random-access device includes a plurality of areas, the plurality of areas include a text area;
an operating system medium, wherein the operating system medium stores an operating system and a first verification media;
at least one game assets media, wherein the at least one game assets media stores at least one game asset file;
a wager acceptor; and
at least one processor configured to receive the plurality of instructions, which when executed by the at least one processor, cause the at least one processor to operate with the at least one of the operating system media, the at least one game assets media, and the wager acceptor to:
a. scan the text area and compare the scanned text area to the first verification media to verify that the scanned text area and the first verification media are the same.

2. The electronic gaming system of claim 1, wherein the at least one game assets media stores a second verification media.

3. The electronic gaming system of claim 2, wherein the at least one processor configured to receive the plurality of instructions, which when executed by the at least one processor, cause the at least one processor to operate with the at least one of the operating system media, the at least one game assets media, and the wager acceptor to scan the text area and compare the scanned text area to the first verification media and the second verification media to verify that at least one of the scanned text area and the first verification media and the scanned text area and the second verification media are the same.

4. The electronic gaming system of claim 3, wherein at least a part of the plurality of instructions are to validate a dirty bit.

5. The electronic gaming system of claim 2, wherein at least a part of the plurality of instructions are to validate a dirty bit.

6. The electronic gaming system of claim 1, wherein at least a part of the plurality of instructions are to validate a dirty bit.

7. An electronic gaming system comprising:
one or more gaming devices, the one or more gaming devices each include:
a) at least one read-only memory device, wherein the at least one read-only memory device stores a plurality of instructions;
b) at least one random-access device, wherein the at least one random-access device includes a plurality of areas, the plurality of areas include a text area;
c) an operating system medium, wherein the operating system medium stores an operating system and a first verification media;
d) at least one game assets media, wherein the at least one game assets media stores at least one game asset file;
e) a wager acceptor; and
f) at least one processor configured to receive the plurality of instructions, which when executed by the at least one processor, cause the at least one processor to operate with the at least one of the operating system media, the at least one game assets media, and the wager acceptor to:
a. scan the text area and compare the scanned text area to the first verification media to verify that the scanned text area and the first verification media are the same;
one or more servers including one or more server processors and one or more server memory devices.

8. The electronic gaming system of claim 7, wherein the at least one game assets media stores a second verification media.

9. The electronic gaming system of claim 8, wherein the at least one processor configured to receive the plurality of instructions, which when executed by the at least one processor, cause the at least one processor to operate with the at least one of the operating system media, the at least one game assets media, and the wager acceptor to scan the text area and compare the scanned text area to the first verification media and the second verification media to verify that at least one of the scanned text area and the first verification media and the scanned text area and the second verification media are the same.

10. The electronic gaming system of claim 9, wherein at least a part of the plurality of instructions are to validate a dirty bit.

11. The electronic gaming system of claim 8, wherein at least a part of the plurality of instructions are to validate a dirty bit.

12. The electronic gaming system of claim 7, wherein at least a part of the plurality of instructions are to validate a dirty bit.
